(19) United States
(12) Patent Application Publication
(10) Pub. No.: US 2015/0120581 A1
(43) Pub. Date: Apr. 30, 2015

(54) COMPUTER IMPLEMENTED FRAMEWORKS AND METHODOLOGIES CONFIGURED TO ENABLE PROCESSING AND MANAGEMENT OF DATA RELATING TO LEASE APPLICATIONS

(71) Applicant: HOUSL Pty Ltd, Sydney (AU)

(72) Inventor: Stuart RUTHERFORD, Sydney (AU)

(21) Appl. No.: 14/523,267

(22) Filed: Oct. 24, 2014

(30) Foreign Application Priority Data
Oct. 25, 2013 (AU) 2013904121
Nov. 29, 2013 (AU) 2013101591
Nov. 29, 2013 (AU) 2013101592

(51) Int. Cl. G06Q 30/06

(52) U.S. Cl. CPC G06Q 30/0645
USPC 705/307

(57) ABSTRACT

The present invention relates to computer implemented frameworks and methodologies configured to enable processing and management of data relating to lease applications. Embodiments of the invention have been particularly developed thereby to increase efficiencies for parties on each side of a lease application. While some embodiments will be described herein with particular reference to that application, it will be appreciated that the invention is not limited to such a field of use, and is applicable in broader contexts. In particular, it should be appreciated that various aspects of technology described herein, whilst described by reference to the example of lease applications, find utility in other fields including education, healthcare, and the like.

### FIELD OF THE INVENTION

The present invention relates to computer implemented frameworks and methodologies configured to enable processing and management of data relating to lease applications. Embodiments of the invention have been particularly developed thereby to increase efficiencies for parties on each side of a lease application. While some embodiments will be described herein with particular reference to that application, it will be appreciated that the invention is not limited to such a field of use, and is applicable in broader contexts. In particular, it should be appreciated that various aspects of technology described herein, whilst described by reference to the example of lease applications, find utility in other fields including education, healthcare, and the like.

### BACKGROUND

Any discussion of the background art throughout the specification should in no way be considered as an admission that such art is widely known or forms part of common general knowledge in the field.

A property owner typically engages a property agent to manage the process of property leasing. The agent organises house inspections to find prospective renters who may then put in a lease application by filling in a paper form. The completed forms are then reviewed and processed by the agent. In some cases, having reviewed the completed forms, a recommended shortlist is presented to the owner to decide on the successful applicant.

### SUMMARY OF THE INVENTION

It is an object of the present invention to overcome or ameliorate at least one of the disadvantages of the prior art, or to provide a useful alternative.

One embodiment provides a computer-implemented method configured to enable ranking of property lease applications, the method comprising:
providing an interface that is configured to receive, from a plurality of applicant users of remote terminals, respective sets of lease application data for property lease applications;
based on the received data, maintaining a database of lease applications;
applying a rating algorithm thereby to rate each of a plurality of lease applications, wherein the rating algorithm rates each application according to a plurality of predetermined criterions (C1, C2 . . . Cn) having associated weights (W1, W2, . . . Wn), wherein the criterions are scored individually for each application, and wherein the weights are applied consistently across lease applications made in respect of a given property;
providing a weighting modification interface configured to enable a user to define values for one or more of the associated weights (W1, W2, . . . Wn) to be applied by the rating algorithm in respect of lease applications made in respect of a given property, thereby to influence the rating algorithm; and
providing output indicative of a ranking of a set of lease applications made in respect of a given property based on application of the rating algorithm as influenced by the values defined via the weighting modification interface.

One embodiment provides a computer-implemented method wherein the predetermined criterions are one or more of:
based on income;
based on credit rating information;
based on employment history;
based on a rating determined by the property agent; and
based on whether identification of one or more lease applicants of a lease application have been verified.

One embodiment provides a computer-implemented method wherein the weighting modification interface enables the agent user to, following output of the ranking, define updated values for one or more of the associated weights (W1, W2, . . . Wn), such that the rating algorithm subsequently applies the updated values.

One embodiment provides a computer-implemented method wherein the weighting modification interface is configured to be accessed by a user registered as a property lease agent.

One embodiment provides a computer-implemented method configured to enable ranking of property lease applications, the method comprising:
(a) providing an interface determining a rating for each of the two or more lease applications submitted for a property according to predetermined criteria and associated weights;
(b) providing over the communications network a computer generated second user interface to a property agent to review a ranking of the two or more lease applications submitted for the property based on the ratings, and to receive from the property agent one or more updated weights;
(c) determining an updated rating for one or more lease applications submitted for the property according to the one or more updated weights; and
(d) providing over the communications network an updated computer generated second user interface to the property agent to review an updated ranking of the two or more lease applications based on the updated rating.

One embodiment provides a computer-implemented method for property lease over a communications network, the method comprising:
generating a token that uniquely identifies a property for lease, wherein the token is readable by a mobile device thereby to provide a request to a server device over a communications network, the request being indicative of the property;
in response to the request, providing over the communications network a first user interface configured to enable a user of the mobile device to submit a lease application in respect of the property scanned; and
providing over the communications network a second user interface to a property agent to review lease applications submitted via the first user interface.

One embodiment provides a computer-implemented method, wherein the token includes a graphic is optically readable by the mobile device.

One embodiment provides a computer-implemented method wherein the wherein the lease applications are ranked according to predetermined criteria, the predetermined criteria being one or more of:
based on income;
based on credit rating information;
based on employment history;
based on a rating determined by the property agent; and
based on whether identification of one or more lease applicants of a lease application have been verified.

One embodiment provides a computer-implemented method wherein the first user interface configured to enable a user of the mobile device to invite a further user to submit co-applicant data in respect of the lease application.

One embodiment provides a computer-implemented method for property lease over a communications network, the method comprising:
generating a graphic that uniquely identifies a property for lease, wherein the graphic encodes at least a link to a computer generated first user interface for lease application submission;
providing over the communications network the computer generated first user interface to lease applicants to each submit a lease application for the property for lease when the code is scanned; and
providing over the communications network a computer generated second user interface to a property agent to review lease applications submitted via the computer generated first user interface, wherein the lease applications are ranked according to predetermined criteria.

One embodiment provides a computer-implemented method configured to enable ranking of property lease applications, the method comprising:
providing an interface that is configured to receive, from a plurality of applicant users of remote terminals, respective sets of lease application data for property lease applications;
based on the received data, maintaining a database of lease applications;
applying a rating algorithm thereby to rate each of a plurality of lease applications, wherein the rating algorithm rates each application according to a plurality of predetermined criterions (C1, C2 . . . . Cn) having associated weights (W1, W2, . . . Wn);
providing output indicative of a ranking of a set of lease applications made in respect of a given property based on application of the rating algorithm; and
providing an output indicative of characteristics of a set of the lease applications based on a defined one or more criterions.

One embodiment provides a computer-implemented method, wherein the predetermined criterions are one or more of:
based on income;
based on credit rating information;
based on employment history;
based on a rating determined by the property agent; and
based on whether identification of one or more lease applicants of a lease application have been verified.

One embodiment provides a computer-implemented method wherein the output indicative of characteristics of a set of the lease applications includes one or more graphs.

One embodiment provides a computer-implemented method wherein one of the graphs is indicative of income characteristics for a plurality of lease applications.

One embodiment provides a computer-implemented method wherein the set of lease applications relate to either: (i) a common property; or (ii) multiple properties satisfying common search criteria.

One embodiment provides a computer-implemented method configured to enable ranking of property lease applications, the method comprising:
providing an interface that is configured to receive, from a plurality of applicant users of remote terminals, respective sets of lease application data for property lease applications;
based on the received data, maintaining a database of lease applications;
applying a rating algorithm thereby to rate each of a plurality of lease applications, wherein the rating algorithm rates each application according to a plurality of predetermined criterions (C1, C2 . . . . Cn) having associated weights (W1, W2, . . . Wn);
applying a preference filtering algorithm thereby to score each of the plurality of lease applications based on user-defined filter settings;
providing output indicative of a ranking of a set of lease applications made in respect of a given property based on application of the rating algorithm in combination with the preference filtering algorithm.

One embodiment provides a computer-implemented method wherein the predetermined criterions are one or more of:
based on income;
based on credit rating information;
based on employment history;
based on a rating determined by the property agent; and
based on whether identification of one or more lease applicants of a lease application have been verified.

One embodiment provides a computer-implemented method wherein the preference filtering algorithm affects the order of one or more lease applications in the ranking.

One embodiment provides a computer-implemented method wherein the preference filtering algorithm affects the presence of one or more lease applications in the ranking.

One embodiment provides a computer-implemented method wherein the preference filtering algorithm defines scores which are displayed in conjunction with the ranking.

One embodiment provides a computer-implemented method configured to enable ranking of property lease applications, the method comprising:
providing an interface that is configured to receive, from a plurality of applicant users of remote terminals, respective sets of lease application data for property lease applications;
based on the received data, maintaining a database of lease applications;
wherein a first given lease application is associated with a single applicant user; and
wherein a second given lease application is associated with multiple applicant users.

One embodiment provides a computer-implemented method wherein the interface is configured to enable a first applicant user to invite a further user to submit co-applicant data in respect of a given lease application associated with the first applicant.

One embodiment provides a computer-implemented method including applying a rating algorithm thereby to rate each of a plurality of lease applications, wherein the rating algorithm rates each application according to a plurality of predetermined criterions (C1, C2 . . . . Cn) having associated weights (W1, W2, . . . Wn).

One embodiment provides a computer-implemented method including providing output indicative of a ranking of a set of lease applications made in respect of a given property based on application of the rating algorithm.

One embodiment provides a computer-implemented method wherein the predetermined criterions are one or more of:
based on income;
based on credit rating information;
based on employment history;
based on a rating determined by the property agent; and
based on whether identification of one or more lease applicants of a lease application have been verified.

One embodiment provides a computer-implemented method configured to enable ranking of property lease applications, the method comprising:
providing an interface that is configured to receive, from a plurality of applicant users of remote terminals, respective sets of lease application data for property lease applications;
based on the received data, maintaining a database of lease applications, wherein one or more of the lease application are joint applications, being associated with multiple joint applicants;
applying a rating algorithm thereby to rate each of a plurality of lease applications, wherein the rating algorithm rates each application according to a plurality of predetermined criterions (C1, C2 . . . . Cn) having associated weights (W1, W2, . . . Wn); and
providing output indicative of a ranking of a set of lease applications made in respect of a given property based on application of the rating algorithm;
wherein the rating algorithm is configured to, in respect of a given joint application, rate a first criterion Cx based on characteristics of a selected one of the joint applicants, and rate a second criterion Cy based on combined characteristics of the joint applicants.

One embodiment provides a computer-implemented method wherein the combined characteristics include summed characteristics.

One embodiment provides a computer-implemented method wherein the combined characteristics include averaged characteristics.

One embodiment provides a computer-implemented method wherein the predetermined criterions are one or more of:
based on income;
based on credit rating information;
based on employment history;
based on a rating determined by the property agent; and
based on whether identification.

One embodiment provides a computer-implemented method wherein the interface is configured to enable a first applicant user to invite a further user to submit co-applicant data in respect of a given lease application associated with the first applicant.

One embodiment provides a computer-implemented method configured to enable ranking of property lease applications, the method comprising:
providing an interface that is configured to receive, from a plurality of applicant users of remote terminals, respective sets of lease application data for property lease applications;
based on the received data, maintaining a database of lease applications;
applying a rating algorithm thereby to rate each of a plurality of lease applications, wherein the rating algorithm rates each application according to a plurality of predetermined criterions (C1, C2 . . . Cn) having associated weights (W1, W2, . . . Wn), wherein the criterions are scored individually for each application, and wherein the weights are applied consistently across lease applications made in respect of a given property;
providing output indicative of a ranking of a set of lease applications made in respect of a given property based on application of the rating algorithm as influenced by the values defined via the weighting modification interface; and
providing output indicative of application observations for one or more applications, a set of application observations are predefined, each application observation including a plain language comment and a set of satisfaction rules.

One embodiment provides a computer-implemented method wherein the application observations are configured to automatically objectively provide, to a reviewing user, plain language observations regarding one or more aspects of a given lease applications.

One embodiment provides a computer-implemented method wherein the aspects are limited to positive aspects.

One embodiment provides a computer-implemented method wherein the application observations are configured to provide warning notifications in the case that predefined conditions are met for a given lease application.

One embodiment provides a computer-implemented method wherein the predetermined criterions are one or more of:
based on income;
based on credit rating information;
based on employment history;
based on a rating determined by the property agent; and
based on whether identification of one or more lease applicants of a lease application have been verified.

In some cases a computer-implemented method for property leasing over a communications network comprises:
(a) determining a rating for each of the two or more lease applications submitted for a property according to predetermined criteria and associated weights;
(b) providing over the communications network a computer generated second user interface to a property agent to review a ranking of the two or more lease applications submitted for the property based on the ratings, and to receive from the property agent one or more updated weights;
(c) determining an updated rating for one or more lease applications submitted for the property according to the one or more updated weights; and
(d) providing over the communications network an updated computer generated second user interface to the property agent to review an updated ranking of the two or more lease applications based on the updated rating.

The predetermined criteria may be one or more of:
based on income;
based on employment history;
based on a rating determined by the property agent; and
based on whether identification of one or more lease applicants of a lease application have been verified.

The method may further comprise storing in a datastore the updated rating.

The associated weights may be predetermined for one or more of the predetermined criteria for one or more of:
the property;
owner of the property;
the property agent;
one or more lease applicants associated with a lease application; and
a default in the absence of any of the above.

A computer system for property leasing over a communications network comprises:
a processor to determine a rating for each of the two or more lease applications submitted for a property according to predetermined criteria and associated weights;
a property agent interface module to provide over the communications network a computer generated second user interface to a property agent to review a ranking of the two or more lease applications submitted for the property based on the ratings and to receive from the property agent one or more updated weights;
the processor to further determine an updated rating for one or more lease applications submitted for the property according to the one or more updated weights; and
the property agent interface module to provide over the communications network an updated computer generated second user interface to the property agent to review an updated ranking of the two or more lease applications based on the updated rating.

A computer-implemented method for property leasing over a communications network comprises:
generating a graphic that uniquely identifies a property for lease, wherein the graphic encodes at least a link to a computer generated first user interface for lease application submission;
providing over the communications network the computer generated first user interface to lease applicants to each submit a lease application for the property for lease when the code is scanned; and
providing over the communications network a computer generated second user interface to a property agent to review lease applications submitted via the computer generated first user interface, wherein the lease applications are ranked according to predetermined criteria.

The graphic may be a quick response (QR) code.

The predetermined criteria may be one or more of:
based on income;
based on employment history;
based on a rating determined by the property agent; and
based on whether identification of one or more lease applicants of a lease application have been verified.

The method may further comprise:
providing over the communications network the computer generated second user interface to receive from the property agent one or more updated weights;
determining an updated rating for one or more lease applications submitted for the property according to the one or more updated weights; and
providing over the communications network an updated computer generated second user interface to the property agent to review an updated ranking of the two or more lease applications based the updated ranting.

A computer system for property leasing over a communications network comprises:
a processor to generate a graphic that uniquely identifies a property for lease, wherein the graphic encodes at least a link to a computer generated first user interface for lease application submission;
lease applicant interface module to provide over the communications network the computer generated first user interface to lease applicants to each submit a lease application for the property for lease when the code is scanned; and
property agent interface module to provide over the communications network a computer generated second user interface to a property agent to review lease applications submitted via the computer generated first user interface, wherein the lease applications are ranked according to predetermined criteria.

Software, being machine readable instructions, when executed by a computer causes the computer to perform any of the methods described above.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

By way of non-limiting examples, embodiment(s) of the present disclosure will be described with reference to the following drawings, in which:

FIG. 1 is a schematic diagram of an example architecture of a computer system for property leasing;

FIG. 2(a) is a schematic diagram of an example user interface module implemented by a server in FIG. 1 for communication with lease applicants and property agents;

FIG. 2(b) is a flowchart of an example process implemented by the server in FIG. 2(a) based on communication with lease applicants;

FIG. 2(c) is a flowchart of an example process implemented by the server in FIG. 2(a) based on communication with property agents;

FIG. 3 is an example user interface for providing personal information of a lease applicant during registration;

FIG. 4(a), FIG. 4(b), FIG. 4(c) and FIG. 4(d) are example user interfaces for providing employment information, rental history information supporting documents and employment history respectively during registration;

FIG. 5 is an example user interface for initiating identification (ID) verification;

FIG. 6(a), FIG. 6(b), FIG. 6(c) and FIG. 6(d) are example user interfaces for providing agent information, application conditions, lease fee information and holding deposit information respectively during registration;

FIG. 7(a), FIG. 7(b) and FIG. 7(c) are example user interfaces for managing properties for lease and lease applications;

FIG. 8 is an example user interface for establishing information of a property for lease;

FIG. 9(a) is an example flyer that includes a graphic generated to identify a property for lease;

FIG. 9(b) is an example user interface for creating a viewing report for a property;

FIG. 10(a) is an example user interface for reviewing lease applicants for a property;

FIG. 10(b), FIG. 11(a), FIG. 11(b), FIG. 11(c), FIG. 12(a), FIG. 12(b) and FIG. 12(c) are example user interfaces for reviewing details of a lease application;

FIG. 13(a) and FIG. 13(b) are example user interfaces for providing an offer for a property to a successful lease application;

FIG. 14 is an example user interface showing the progress of a property that has been awarded to a successful lease application;

FIG. 15 is a schematic diagram of an example structure of a mobile electronic device for use by a lease applicant or agent;

FIG. 16 is a schematic diagram of an example structure of a server; and

FIG. 17 is an example email sent to a secondary lease applicant;

FIG. 18 is an example user interface for reviewing a joint applicant lease application; and

FIG. 19 is an example user interface for reviewing details of a lease application having joint applicants.

### DETAILED DESCRIPTION

Described herein are computer implemented frameworks and methodologies configured to enable processing and management of data relating to lease applications. Embodiments of the invention have been particularly developed thereby to increase efficiencies for parties on each side of a lease application. While some embodiments will be described herein with particular reference to that application, it will be appreciated that the invention is not limited to such a field of use, and is applicable in broader contexts. In particular, it should be appreciated that various aspects of technology described herein, whilst described by reference to the example of lease applications, find utility in other fields including education, healthcare, and the like.

### Exemplary Framework

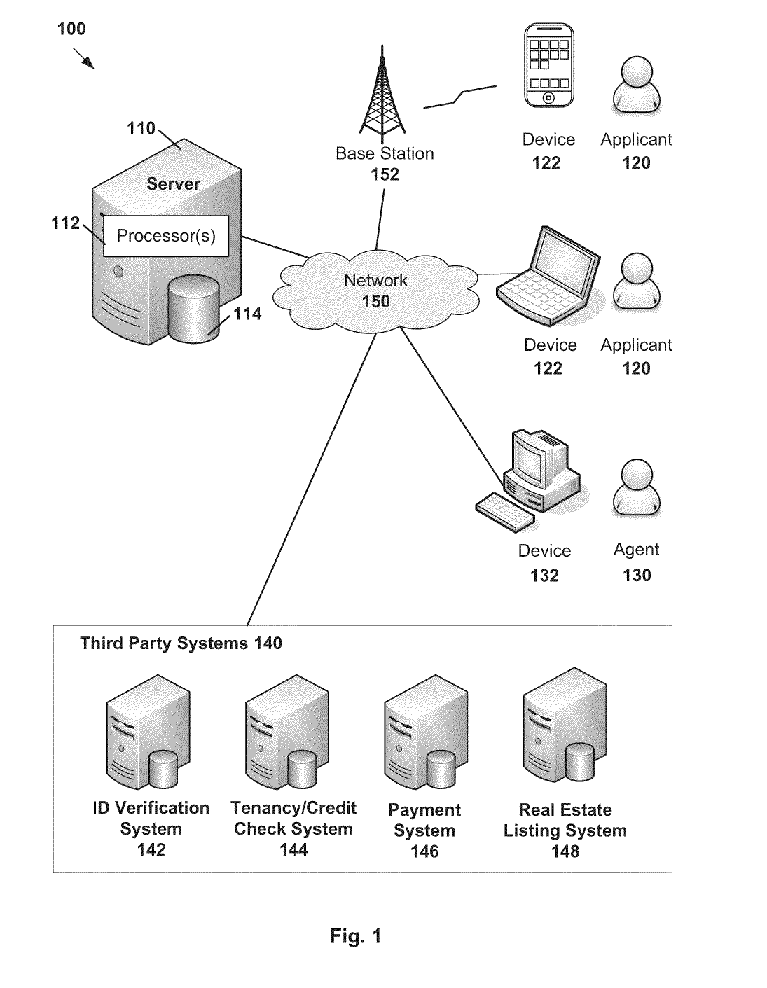

FIG. 1 shows an example computer implemented framework, described as a system 100, configured to assist in the field of property leasing, for example be enabling lease applications by lease applicants 120 and management of lease applications by property agents 130. The system 100 includes a server 110 in communication with multiple computing devices operated by lease applicants 120 and property agents 130 over a communications network 150 and, where applicable, a wireless communications network 152.

The lease applicants 120 and agents 130 each operate a device 122, 132 to communicate with the server 110. The device 122, 132 may be any suitable Internet-capable electronic device, such as a mobile device (e.g. smartphone), personal digital assistant, tablet computer, desktop computer and laptop computer. A lease applicant 120 may be any entity that is seeking to lease a property, such as an individual, a group of individuals or a company. A property agent 130 may be a leasing agent, property manager, property owner or any other entity with suitable authority. Although not shown, the server 110 may communicate with a content management system (CMS) and client relationship management (CRM) system to extract any information relevant to property leasing.

The server 110 is also in communication with third party systems 140, such as an identification (ID) verification system 142, tenancy and/or credit check system 144, payment processing system 146 and real estate listing system 148. The ID verification system 142 may be used to verify the identity of lease applicants 120 and agents 130. The tenancy and/or credit check system may be used to verify tenancy and/or credit history information provided by lease applicants 120. Although not shown, the server 110 may also be in communication with any other suitable systems, such as systems operated by relevant government authorities and other systems operated by the agent 130, such as the agent's website, accounting system and web portal.

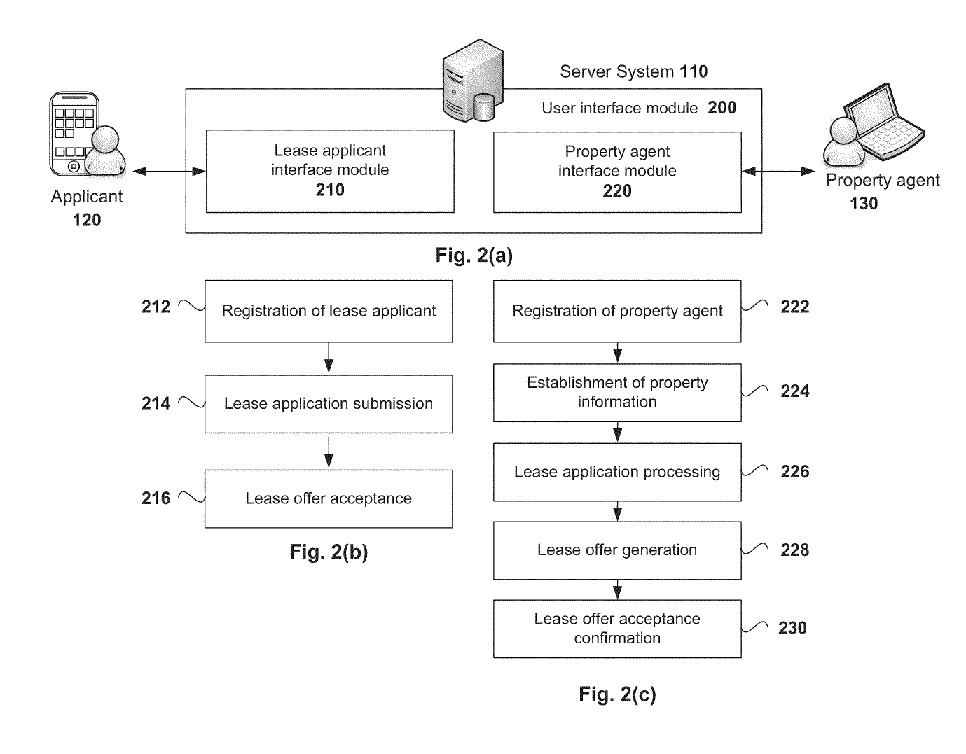

The server 110 includes at least one processor 112 and data store 114 (one shown for simplicity). Referring also to FIG. 2(a), the processor 112 implements a user interface module 200 to handle communication from the lease applicants 120 and agents 130 to utilise online property leasing services provided by the server 110. All information on agent's properties and the respective associated status is stored in the datastore 114. In one example, the datastore is separated into three databases. The first database stores records on registered agents 130. The second database stores records on registered lease applicants 120. The third database stores records of properties and associated lease applications. The three databases may be part of a database management system (DBMS) such that the records of the different databases are associated with each other, typically using repeated fields that unique identify records of a different database. Each of the three databases may each be comprised of multiple databases and may be stored in a distributed manner.

In FIG. 2(a), the example user interface module 200 includes the following:
A lease applicant interface module 210 allows lease applicants 120 to connect with and utilise services provided by the server 110. As shown in FIG. 2(b), the server 110 provides, via the lease applicant interface module 210, a “first user interface” for lease applicants 120 to register 212, submit lease applications 214, and accept lease offers 216. The module 210 may also allow a lease applicant 120 to make a payment (e.g. holding deposit and rent) to an agent 130 via the server 110 and payment system 146.
A property agent interface module 220 allows property agents 130 to connect with and utilise services provided by the server 110. As shown in FIG. 2(c), the server 110 provides, via the property agent interface module 220, a “second user interface” for agents 130 to register 222, establish property information 224, process lease applications 226, generate lease offers 228 and receive confirmation of acceptance of lease offers 230. Additionally, the module 220 may allow an agent 130 to verify information provided by the lease applicants 120 and import property information from a third party server (e.g. real estate listing system 148).

In one example, during the process of establishing property information at 224 in FIG. 2(c), the server 110 generates a token, which may for example by a wirelessly readable token or a token defined by an optically observable graphic. The token is also referred to herein as a “code”, and uniquely identifies a property for lease. The term “generate here” means either dynamically at that time, typically in real time or selection from a pre-generated set of tokens. The token is readable by a computing device, for example a smartphone reads the token using an available sensor (for example a RFID reader in the case of an RFID token, a camera in the case of a graphical token, or a Bluetooth module in the case of an iBeacon or other Bluetooth readable token). Reading the token causes the device to access a remotely provided location that provides an electronically fillable lease application. For instance, in one embodiment the token encodes at least a link to a first user interface for lease application submission for the property for lease.

In some embodiments a token is defined by reference to GPS coordinate data for a property. In such embodiments, GPS data received from a mobile device's GPS module is decoded thereby to provide access to a lease application for a relevant property based on the mobile device's location.

An example of a graphical token is a 2-dimensional Quick Response (QR) code or other variants similar to the QR code (including those not yet developed) but are suitable for in the context described here. When the token is scanned by a camera module of device 122 of a lease applicant 120, which typically involves an image capture of the graphic by the device 122, the token is decoded to identify the link. The link directs the server 110 to provide the first user interface to lease applicants 120 to submit a lease application, typically by sending the device 122 the content of the first user interface. The server 110 then provides a second user interface to a property agent to review lease applications submitted via the first user interface. Again, this is typically by sending to the device 132 the content of the second user interface. To facilitate selection of a successful lease application, the lease applications are ranked according to predetermined criteria. Further, the second user interface allows the property agent to provide to the server 110 updated weights that are used by the server 110 to determine an updated ranking. Further, being able to dynamically adjust the weights so that an updated ranking that better reflects the property agent's requirements will greatly assist the agent in reviewing the lease applications, particularly in prioritising their efforts in reviewing only the best lease applications for a property.

From the lease applicants' perspective, lease application is made easier and simpler because the first user interface for lease application is identified once the token or code is scanned. This reduces, if not avoids, the need for lease applicants to fill in paper forms and hand them to property agents for consideration. From the agents' perspective, the process of reviewing lease applications is also made easier and simpler because all lease applications submitted for a particular property will be accessible from the server 110. This also avoids the needs to collect paper forms and/or enter handwritten information of lease applications 120 into a computer data store. Further, ranking of the lease applicants 120 help the property agent 130 to perform a comparison in a more informed way to select the successful applicant.

The registration process 212 in FIG. 2(b) may include ID verification of the lease applicants 120 by the server 110 via the ID verification system 142. Similarly, the identity of property agents 130 and/or associated agencies may be verified during registration at 222 in FIG. 2(c). Various technologies for ID verification may be used, for example those provided by third party technology providers.

It will be appreciated that the “first user interface” and “second user interface” provided by the server 110 may be in any suitable form, such as web pages and software application (App) interfaces that may be displayed on a lease applicant's device 122 or agent's device 132. The “first user interface” and “second user interface” may each include multiple user interfaces and may be optimised based on the device 122, 132 used, such as its type, operating system and browser type and version.

Although not shown in FIG. 2, the user interface module 200 may further include other modules to communicate with other users of the server 110, such as administrators and third party service providers associated with the external systems 140.

Example processes in FIG. 2(b) and FIG. 2(c) will be explained below.

Although examples are described by particular reference to situations where a token is used to automatically divert a user's mobile device to a lease application interface for a specific property, the invention is not limited as such. There are various other ways in which a user may access a lease application interface for a specific property, including via websites (including third party websites), emailed links, and so on.

### Registration of Lease Applicants

The registration process according to block 212 in FIG. 2(b) includes the server 110 receiving information from lease applicants 120 via one or more user interfaces and storing the information in the datastore 114 a record for the lease applicant 120. The registration process may also include ID verification of the lease application 120.

In one example, when lease applicants 120 log onto the server 110 for the first time, they will be required to provide an email address and password to set up their account. An email will then be sent to the email address for confirmation. The lease applicants 120 may then log onto their account to provide various information.

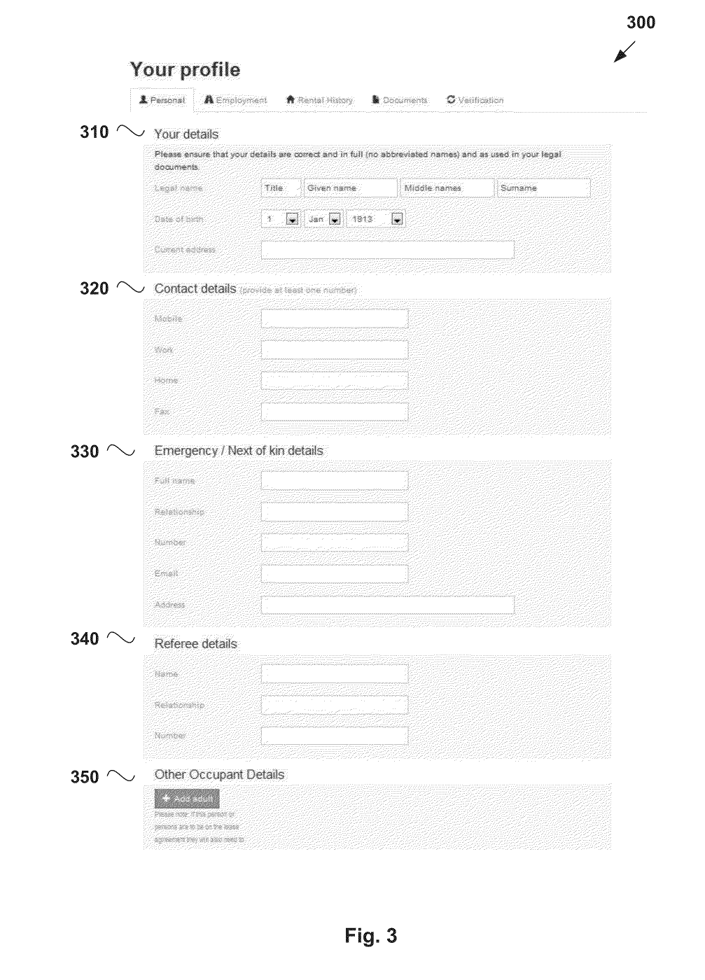

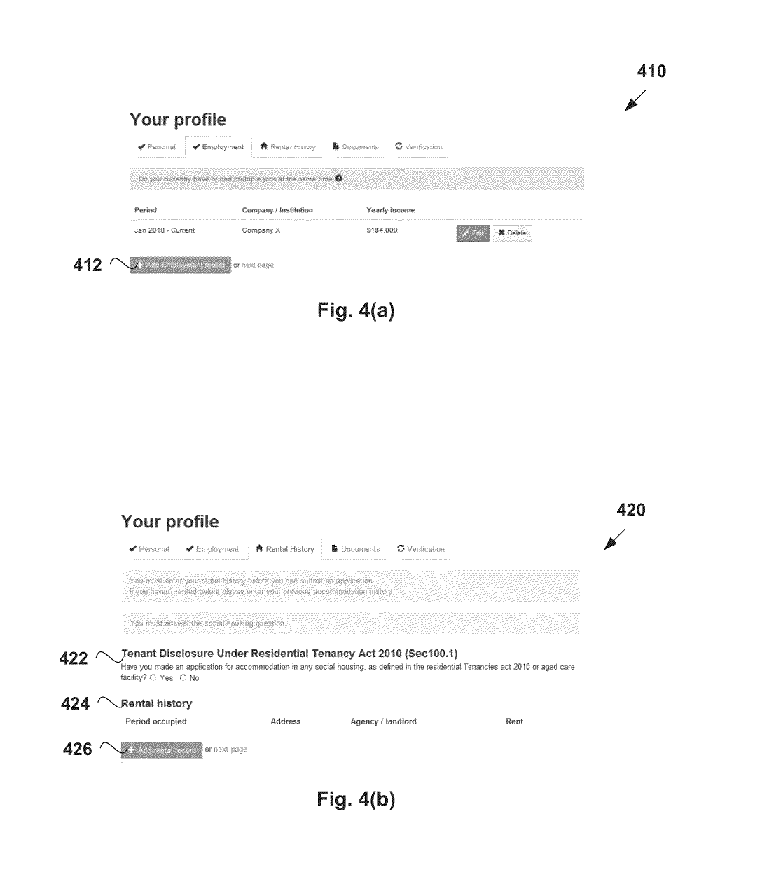

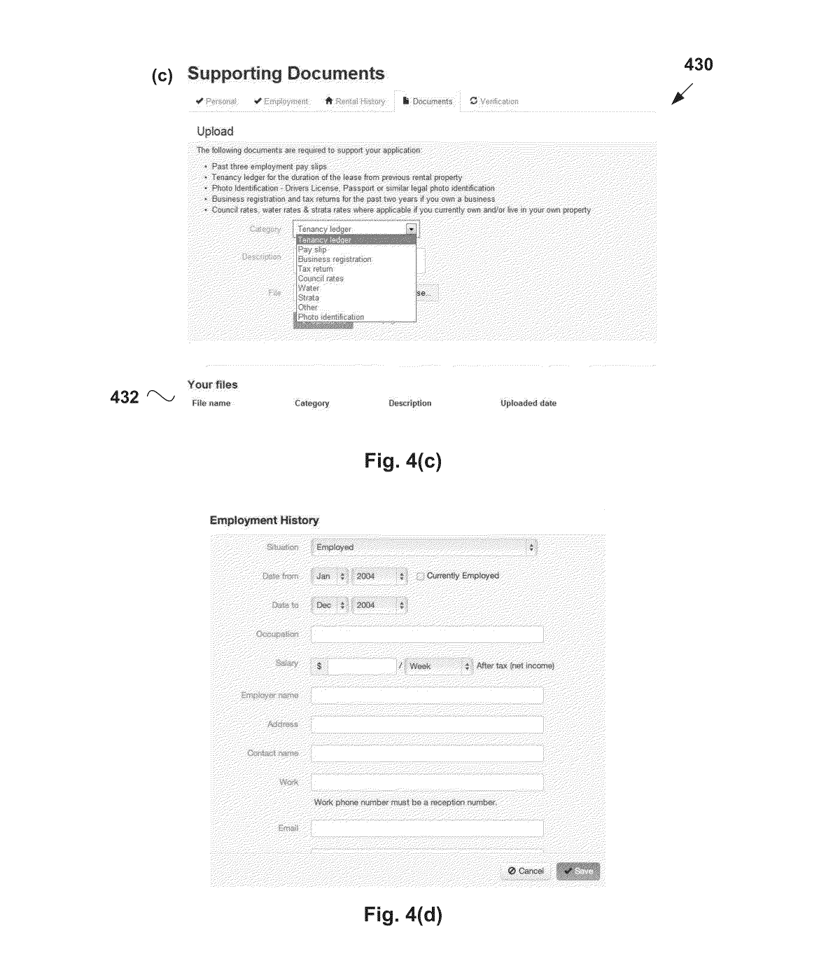

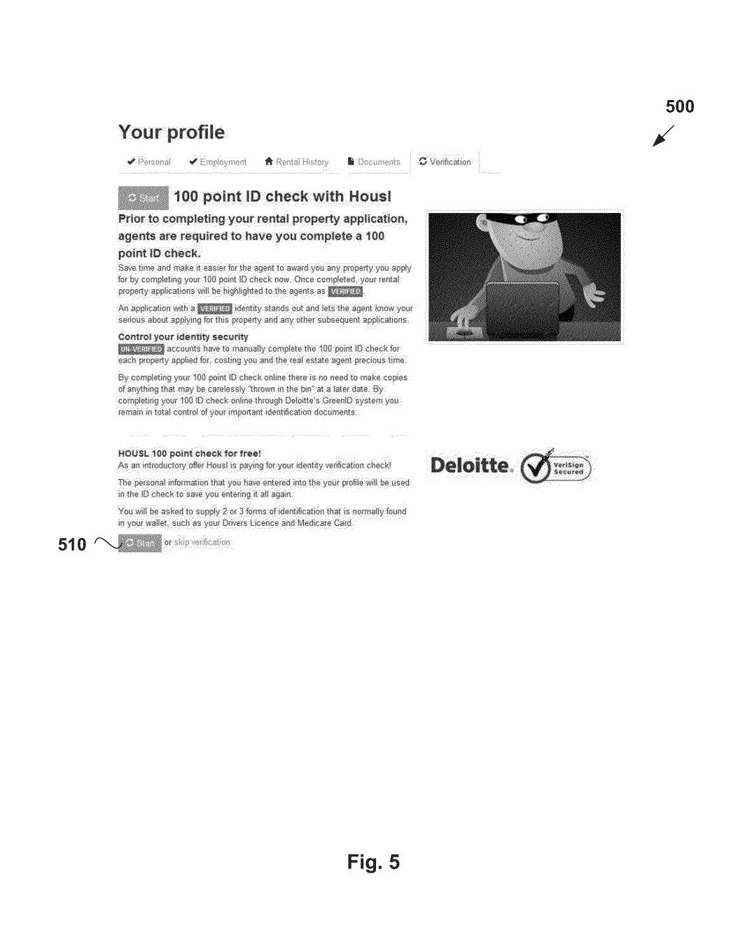

Example user interfaces (i.e. tabs “Personal”, “Employment”, “Rental History”, “Documents” and “Verification”) are shown in FIG. 3, FIG. 4 and FIG. 5. The information received by the server 110 may include one or more of the following:
Personal information of the lease applicant 120, provided via the “Personal” tab; see FIG. 3. The example interface 300 provides various text and drop-down boxes for the lease applicant 120 to provide personal information such as applicant's details 310 (e.g. name, date of birth, current address), contact details 320 (e.g. mobile, work, home and fax numbers), emergency contact or next of kin details 330 (e.g. full name, relationship, number, email, address), referee details 340 (e.g. name, relationship, number).
Employment information of the lease applicant 120, provided via the “Employment” tab; see FIG. 4(a). The example interface 410 allows the lease applicant 120 to create an employment record 412 for current or previous employment at the datastore 114 by the server 110 for each of their current and past jobs. The lease applicant 120 provides information to populate and complete a job record, including whether the job forms their primary or secondary employment. Each record will also receive from the lease applicant 120 information on whether the job is full-time, part-time or casual and the time period of employment for that job. The lease applicant provides for each job a numerical value of the income associated with that record, which in this example is weekly. Although not shown, the employment information may be imported from an external source, such as professional networking website LinkedIn. An example user interface for receiving employment information to create a job record is shown in FIG. 4(d).
Rental history information of the lease applicant 120, provided via the “Rental History” tab; see FIG. 4(b). The example interface 420 allows the lease applicant 120 to provide information relating to previous accommodation by adding a new previous rental record 426 to cause to be stored by the server 100. The record will reflect information on any social housing or aged care facility (see 422) and rental history information (see 424). The latter includes information such as period occupied, address, agency or landlord and rent. Once all relevant information has been provided, a rental record is created by the server 110.
Supporting documents of the lease applicant 120, provided via the “Documents” tab; see FIG. 4(c). The example interface 430 allows the lease applicant 120 to attach documents, such as tenancy ledger from previous rental properties, past employment pay slips, photo identification (e.g. driver's license, passport or similar), business registration and tax return information for business owners, and information of council rates, water rates and strata rates etc. Attached documents are shown at the bottom of the screen; see 432.
ID verification information of the lease applicant 120, provided via the “Verification” tab; see FIG. 5. The example interface 500 requests the lease applicant 120 to complete an identity check” by clicking a “Start” button (510). The server 110 then connects with an external server 140 to verify the personal information provided by the lease applicant 120 (see FIG. 3 and FIG. 4(c) again). Once the verification is successful, the status of the lease applicant 120 changes from “un-verified” (default) to “verified” in the lease applicant's record in the datastore 114. In some embodiments individuals may be pre-identified subject to a third-party issued verification certificate.

In some embodiments employment and/or other financial information is determined and/or verified by reference to bank account records. For example, by obtaining electronic banking details for a user, transaction records may be extracted thereby to determine details such as income, regularity of income, period of regularity of income, regular expenses, and so on. For example, patterns of regular income/expense amounts from common payers/payees are identified. This may allow automated determination of financial profile of an applicant, thereby to assist with ranking and rating as described below. Various algorithms are known for extracting knowledge from banking details, and third party technology providers, such as Yodlee, may be used to assist in extraction and processing of financial transactional data.

### Registration of Agents

The registration process according to block 222 in FIG. 2(c) includes the server 110 receiving information from property agents 130 via one or more second user interfaces and storing the information in the datastore 114 by the server 110. In one example, the first time property agents 130 log onto the server 110, they will be required to provide an email address and password to set up their account. An email will then be sent to the email address for confirmation. The agents 130 may then log onto their account to complete the registration process.

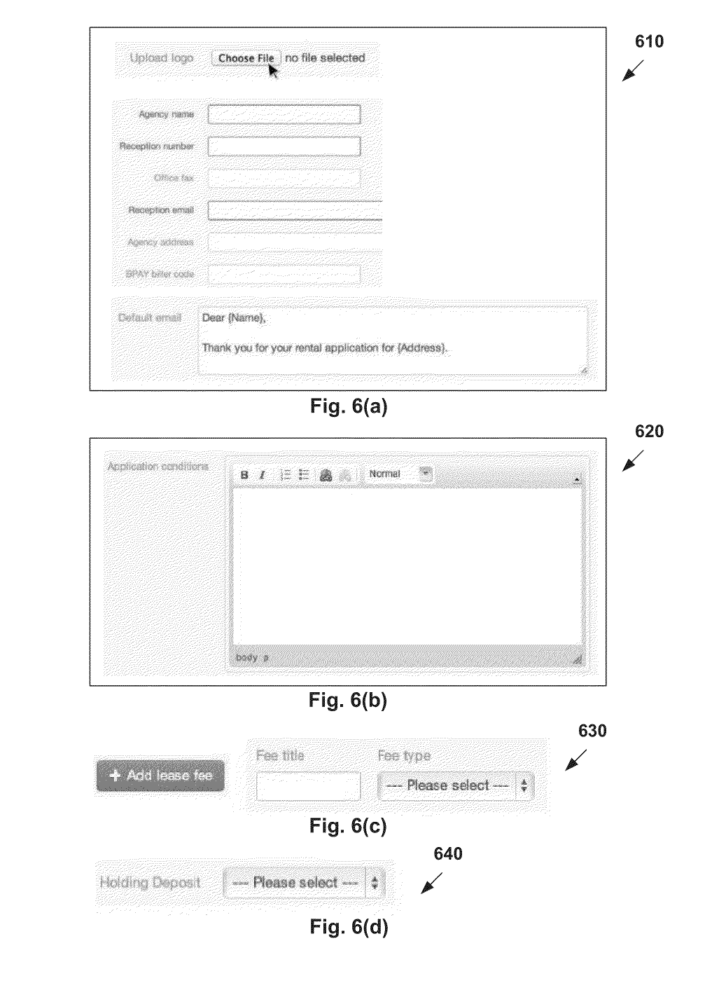

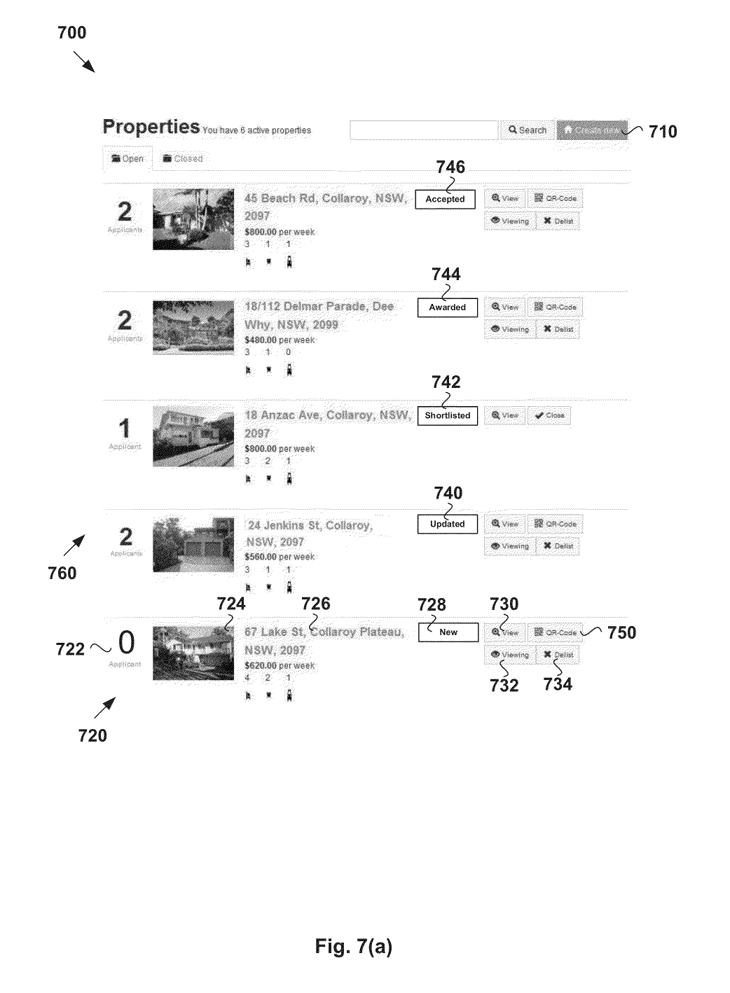

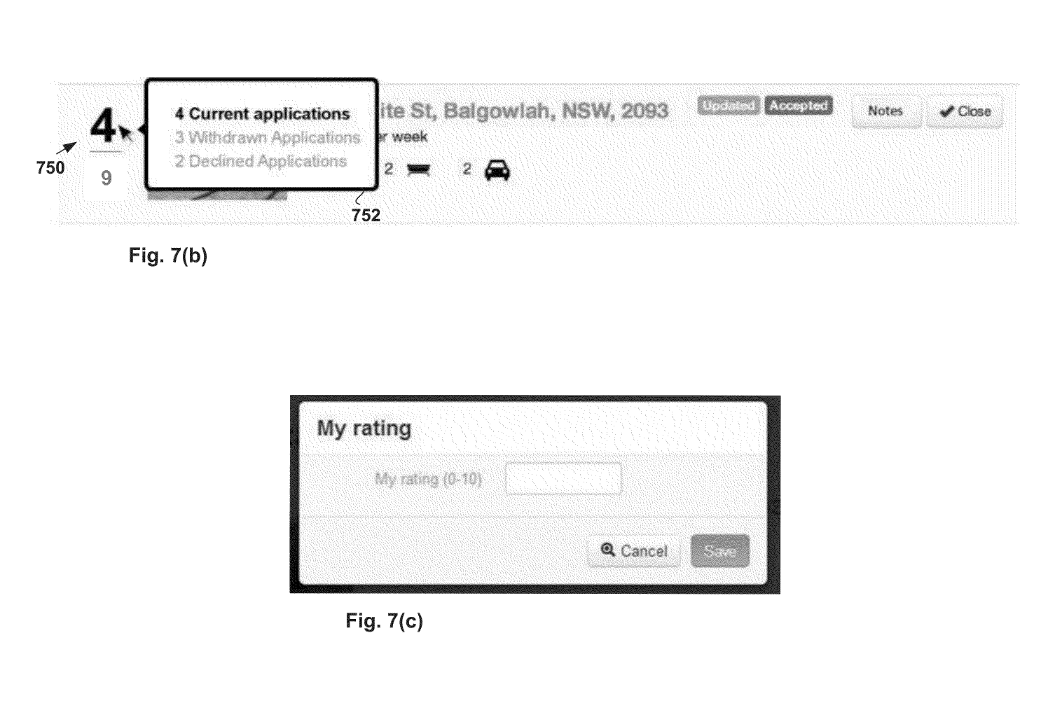

Example user interfaces are shown in FIG. 6 and FIG. 7 for the agents 130 to provide various information such as one or more of:
Agency information; see FIG. 6(a). The example interface 610 provides various user interface elements (e.g. text boxes) for the agent 130 to upload a logo of their agency, and provide details such as agency name, reception number, contact details, biller code and default email to a lease applicant. The default email is used as a template for all emails sent from the agent 130 to lease applicants 120.
Terms and conditions; see FIG. 6(b). The example interface 620 provides a text box (with formatting options) to enter any terms and conditions that the agent 130 requires lease applicants to consent to prior to submitting an application. Lease applicants 120 will be required to accept the terms and conditions during the application process. For example, they may include requiring the lease applicants 120 to declare that all information provided is correct and true. The lease applicants 120 may be required to authorise the agent 130 to contact their references and enter their information into a tenant reference database.
Privacy disclosure statement, for example via a text box similar to FIG. 6(b). This allows the agent 130 to compose a default privacy disclosure statement, which is generally the agency's policy plan. Lease applicants 120 will not be able to apply unless they have accepted the terms specified.
Lease conditions, for example via a text box similar to FIG. 6(b). The conditions may include time period for the lease applicant to sign a lease after their application is successful. The conditions may also include payment options for bond or holding deposit, and preferred payment method for rent.
Additional services offered by the agent 130, for example via a text box similar to FIG. 6(b). The services may include provision of offers or information regarding third party services such as utility connection, Internet connection and paid television subscription. For example, a list of utility providers may be presented to the agent 130 via the user interface for selection. An email will be sent to the agent 130 if the applicant 120 has elected to be contacted.
Lease fee information; see example user interface 630 in FIG. 6(c). This includes any fees a lease applicant 120 must pay before accepting a lease offer, such as bond and holding deposit. A fee title and a fee type (e.g. per week) may be specified for each fee. The lease fee information may be updated by the agent 130 prior to making a lease offer (also referred to as awarding) a property to a lease applicant 120.
Holding deposit requirement; see example user interface 640 in FIG. 6(d). This specifies a deposit required of the lease applicant 120 to hold the property prior to signing the lease. This requirement may be updated by the agent 130 prior to awarding a property to a lease applicant 120.

Although not shown in FIG. 6, agents 130 may be required to complete a ID verification check. Similar to 212 in FIG. 2(b), the registration process may include ID verification of the agents 130 via an ID verification system 142.

### Establishment of Property Information

Once registered, an agent 130 may log onto the server 110 to establish information of properties for lease. FIG. 7(a) shows an example user interface 700 (also referred to as “dashboard” or “property dashboard screen”) provided by the agent interface module 220 according to block 224 in FIG. 2(b).

The user interface 700 shows a list of properties stored as records in the data store 114 and accessible by the agent 130 and associated information and applications. A user interface element 710 (“Create new” button) is provided on the user interface 700 to create a new property record, that is, a new record to be stored in the datastore 114 by the server 110. The term “user interface element” refers to any suitable user interface object presentable to a user via the user's device, such as a list box, text box, drop down menu, combo box, radio button, action bar, etc.

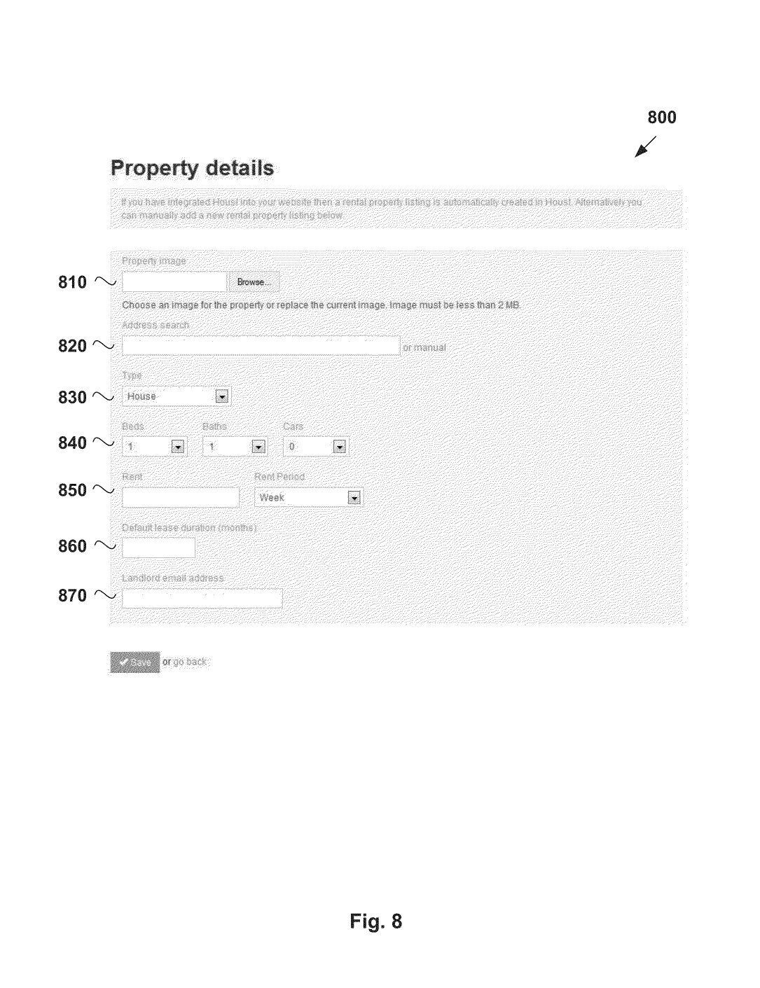

Once the “Create new” button 710 is clicked, an example user interface 800 of FIG. 8 for entering information of a property for lease is provided by the agent interface module 220 at the server 110. The information includes one or more of the following:
At 810, visual diagram of the property for lease, which may be a photograph, sketch, computer-generated image and floor plan of the property. Although not shown, multimedia information such as video (e.g. virtual tour), voice information, data information (e.g. property description), or a combination thereof may be uploaded.
At 820, location information of the property. An address search functionality may be provided. In this case, when an address input into the text box 820 is detected, a drop down menu will appear to complete the address or offer suggestions. If the address does not appear, or displays incorrectly, the address may be entered using the manual option.
At 830, property type such as commercial property, house, duplex, townhouse, unit or apartment.
At 840, property attributes such as number of bedrooms, bathrooms and car spaces.
At 850, rent information such as amount per rental period (entered as either week, fortnight, month etc.).
At 860 the preferred lease duration.
At 870, contact details of landlord, such as email address. This allows the agent 130 to contact the landlord using the server 110, for example to email any summary reports to them.

In one embodiment the elements 810 to 870 may be populated manually by the agent 130. In other embodiments the information may be obtained from other systems, such as real estate listing system 148, which substantially avoids the need for manual entry by the agent 130 into the agent user interface.

Referring to FIG. 7(a) again, the property for lease appears on the dashboard or user interface 700 once its record is created. In this example, the newly created property is shown at 720. The number of applicants 722, image 724, address and attributes 726 and status 728 of the property 720 are shown. At any time, a “Viewing” element 732 may be used to view or create new viewing report, a “Delist” element 734 to remove the property and a “Share” element 730 to share details of the property 722 for lease. Typically this is by generating an email that includes details of the property, including a link to a first user interface for lease application submission for the property for lease. The generated email will also carbon copy (cc) or blind carbon copy (bcc) the relevant property manager to ensure they are aware of the activity.

In some embodiments the “share” functionality enables integration with existing social networks, such as Facebook. Furthermore, in some embodiments module 210 is available in an embedded form that is accessible directly via such a social network (for example a leas application is able to be completed from with an overarching social networking framework, such as Facebook).

The stored status of the property is updated by the server 110 throughout the lease application process:
“New” 728 to indicate that the property has been listed within a predetermined period of time, such as within the last 48 hours.
“Updated” 740 to indicate that the property has had updates (e.g. information updated, new lease application) since the agent 130 last logged on.
“Shortlisted” 742 to indicate that one or more lease applications have been shortlisted for the property by the agent 130.
“Awarded” 744 to indicate that the property has been awarded based on a lease application.
“Accepted” 746 to indicate that a lease applicant 120 of the lease application has accepted a lease offer for the property.

To facilitate lease applications, the interface 700 also provides a token-generation user interface element 750 to generate a token, such as a graphical token, that uniquely identifies a property for lease. Such a graphic encodes information relating to the property for lease, including at least a link (e.g. Uniform Resource Locator or other similar pointer) to a user interface (e.g. website) provided by the server 110 to submit a lease application. Scanning the token or code by a lease applicant's device 122 takes the lease applicant 120 to the user interface encoded in the link.

The applicant's device 122 may be a mobile electronic device equipped with a camera and software application to scan the image of the graphic. Any suitable graphic can be used, in this example a two-dimensional Quick Response (QR) code that generally includes various black squares arranged in a square grid on a white background to encode information is used.

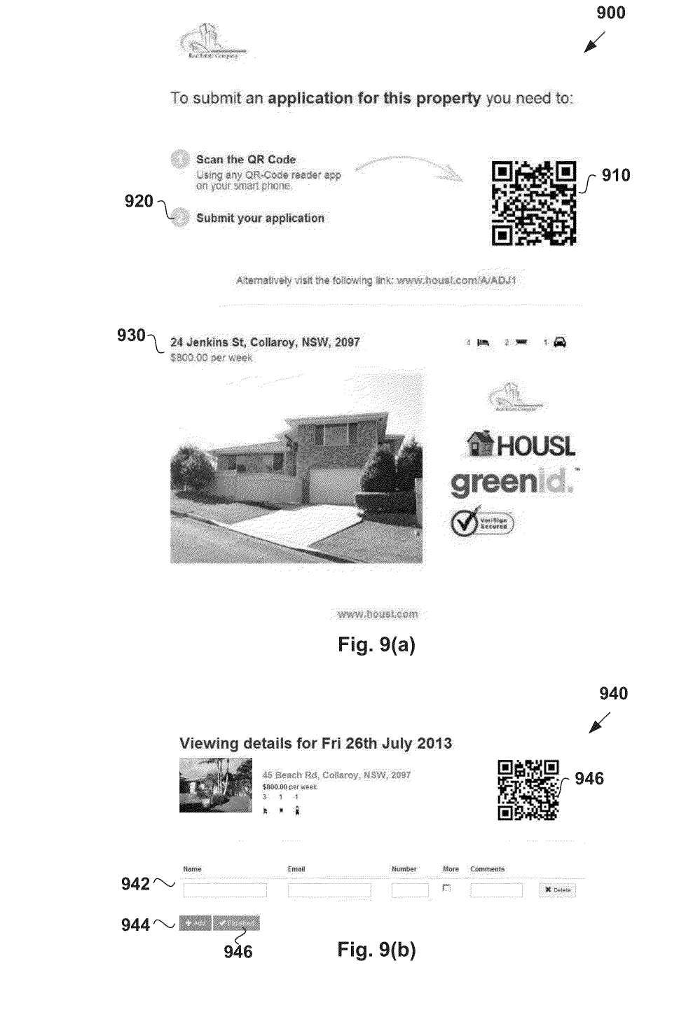

The token-generation element 750 may also be used to generate a flyer, an example 900 of which is shown in FIG. 9(a). The flyer 900 may be printed by the property agent 130 for distribution to potential applicants 120 or simply displayed on a computer screen for scanning by lease applicants 120. The flyer 900 sets out the QR code 910, instructions to applicants to submit an application 920, and other information about the property 930.

FIG. 9(b) shows an example user interface 940 for creating a viewing or property inspection report once the “Viewing” button 732 in FIG. 7(a) is selected. The interface 940 presents various text boxes 942 for entering information of potential lease applicants who attend an inspection for a property, including name, email and phone number. The “more” checkbox may be selected if a potential applicant would like to be contacted with information of other properties for lease. The “Add” button 944 may be selected to add information of further potential applicants. This information is typically entered either at the time of inspection of the property, such as directly into the device 132 of the agent 130, such as a tablet device. Alternatively, the information may be entered after the time of inspections based on paper forms completed by lease applicants 120. Once completed, an inspection report (e.g. in PDF version) may be generated to include details of the potential applicants by selecting the “Finished” element 946. This can then be sent to the landlord's email address as provided by the agent 130 at 870. The interface 940 in FIG. 9(b) also displays the QR code 948 generated for the property.

### Lease Application Submission

The token or code generated for the property via the interface 700 in FIG. 7 may then be used for submitting a lease application according to block 214 in FIG. 2(b).

In FIG. 9(a), scanning of the token or code 910 by a lease applicant's device 122 connects the device 122 to the server 110. A user interface is then provided to the lease applicant 120 for submitting a lease application over the communications network 140. For example, the token or code 910 may be scanned during a house inspection by the lease applicant 120 or at the agent's office. The token or code 946 on the user interface 940 in FIG. 9(b) may be scanned in a similar manner.

To apply, the lease applicant 120 may first be asked to log onto their account for authentication. This also allows the server 110 to identify the lease applicant 120 and retrieve the information previously provided by the lease applicant 120 to generate a lease application. Alternatively, the lease applicant 120 may be identified based on information (e.g. temporary data) stored on the applicant's device 122 without the logging on process.

The lease application user interface 210 may then request the lease applicant 120 to enter any terms they might have, such as rent offer, lease length, lease start date, and any general comments (e.g. a request to the landlord to fix certain features). The lease applicant 120 is then requested to accept the agent's terms and conditions and privacy disclosure policy before the application may be submitted.

Using the online user interface, the lease applicant 120 does not have to fill in any paper forms for the lease application. Instead, the lease application process is performed electronically, and information of the lease applicant 120 is retrieved for the lease application. This saves time and effort, especially if the lease applicant 120 applies for multiple properties at the same time. Since the information provided by the lease applicant 120 is already in electronic form, it is not necessary for agents 130 to enter hand-written lease application information to a database for example.

For lease applicants 120 who are not registered with the server 110, they may be invited to register before a lease application can be submitted. Lease applicants 120 will also have the option of submitting their application later, in which case the property will be saved for later retrieval.

The status of a lease application for a property is changed by the server 110 throughout the lease application process. From the applicant's 120 perspective, the status may be one of the following: “Submitted” if a lease application has been submitted; “Withdrawn” if a lease applicant's application has been withdrawn; “Awarded” if the applicant 120 is successful in the application; “Declined” if the application has not been successful, and “Accepted” if the applicant 120 has accepted the property.

### Lease Application Processing

Once submitted, lease applications may be processed by the server 110. Property agents 130 may connect to the server 110 via the property agent interface module 220 to manage lease applications according to block 226 in FIG. 2(c).

The example user interface 700 in FIG. 7(a) may be used for managing the lease applications. As indicated generally at 760 in FIG. 7(a), two lease applications have been submitted for the property at “24 Jenkins St, Collaroy, NSW, 2097”. FIG. 7(b) shows the information presented when the agent 130 hovers their pointing device over the lease information for 22 Boundary St, Clovelly. In this example at 750 the number of lease applications for the property is shown. The larger bold number, in this case 4, shows the number of active lease applications there are for the property. Underneath and not in bold, in this case, is the number of lease applicants who have applied for this property. To learn more about these numbers the agent 130 hovers their pointing device over the numbers 750 to reveal the pop-up additional user interface indicated at 752. The applicant numbers 750 are broken down into current, withdrawn and declined, and in this case is 4, 3 and 2 respectively.

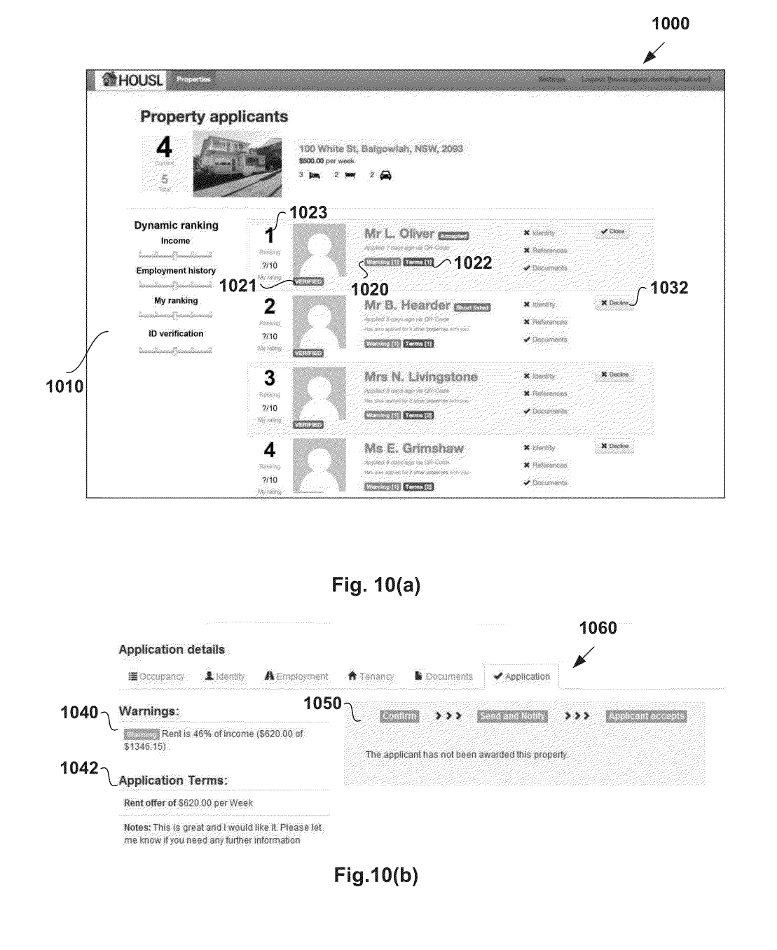

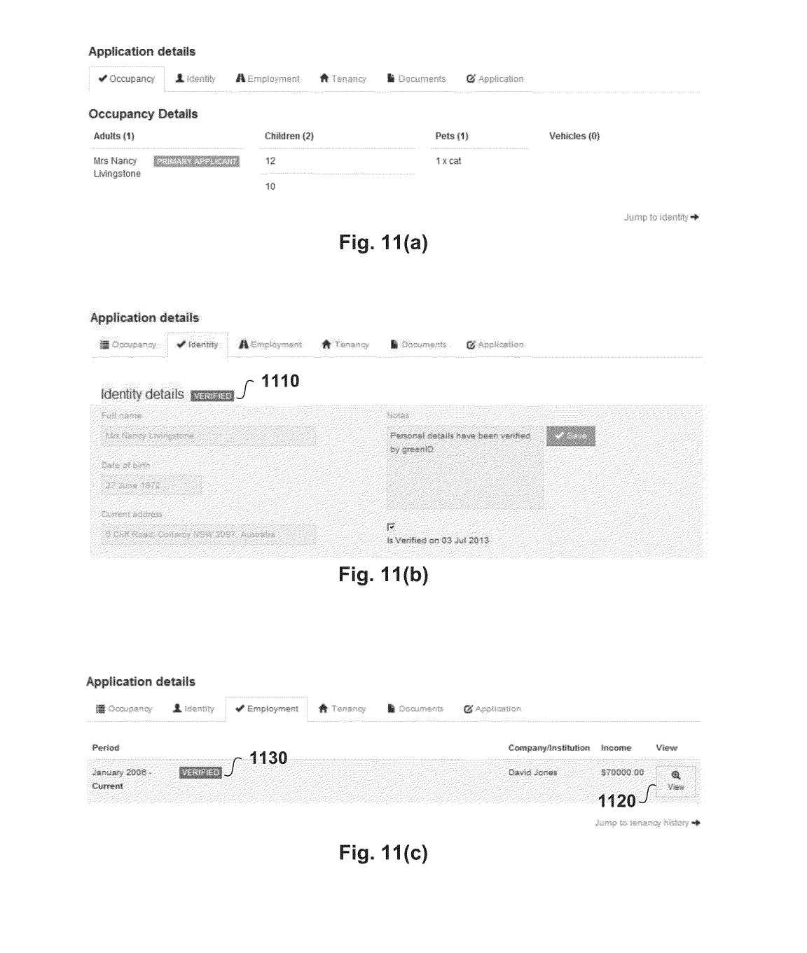

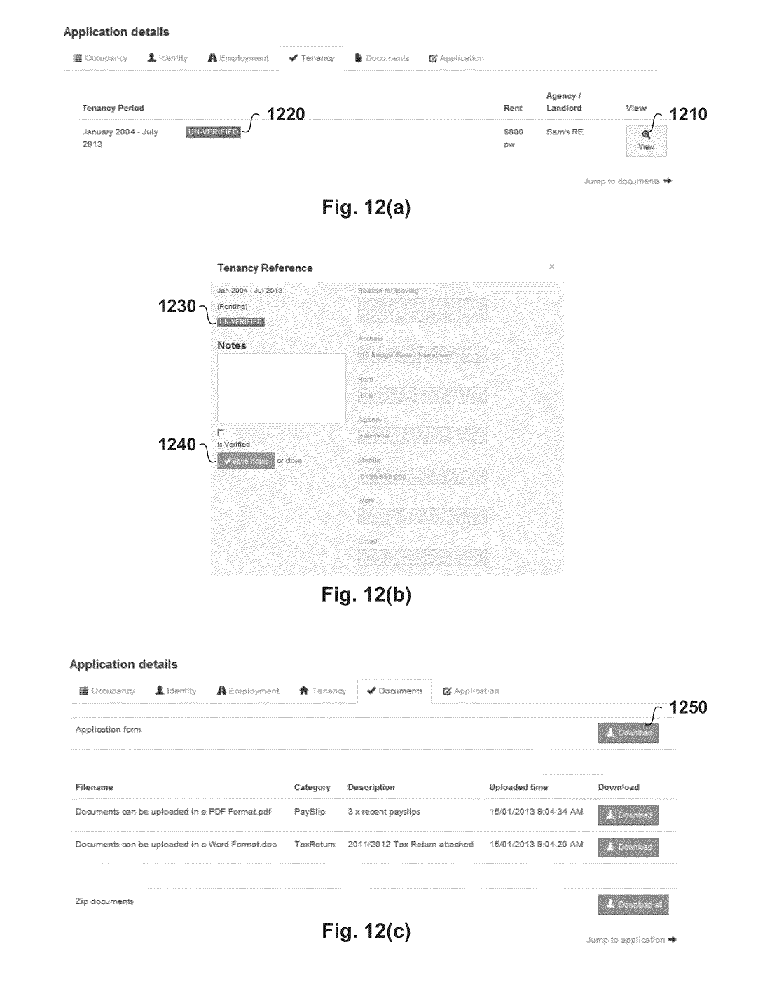

An address of a property may then be clicked to view further details of the lease applications. FIG. 10 is an example user interface 1000 that shows details of the lease applications, such as name (e.g. Mr L. Oliver), when and how the lease application is submitted (e.g. 7 days ago and via QR code), and ID verification status 1021 (verified, un-verified). The interface 1000 also indicates any warnings the server 110 may have for the agent 130 (see “Warning [1]” 1020) and an indication that applicant has lease terms (see “Terms [1]” 1022).

To facilitate selection of a lease application, the server 110 dynamically ranks 1023 the lease applications and displays the ranking on the interface 1000 to assist the agent 130 in reviewing and prioritising the lease applications. This forms part of the lease application processing step of 226 of FIG. 2(c). For example, the agent 130 is able to view on interface 1000 all of the lease applications for a property in priority ranked order before having reviewed a single lease application in detail. Any suitable criteria may be used as the predetermined criteria, such as income, employment history, a manually assigned rating by the agent 130 and whether the lease applicant 120 is verified. An example of another suitable criteria that could be used may be based on rental history. These criteria are used by the server to determine a rating value for each of the two or more lease applications submitted for a property and based on these ratings the lease applications are ranked.

A value for each of the predetermined criteria is determined by the server 110 for each lease application.

For example, for value for income (Value_Income) the server 110 references the income of the lease applicant's 120 current employment, including casual or part-time income, they may be receiving. The server 110 accesses the income information entered by the lease applicant 120 and stored in the datastore 114 to determine an estimate for the yearly income of the lease applicant as Value_Income. A warning 1020 for the agent 130 appears on the lease application if any additional casual or part-time income has been included in Value_Income.

For example, for the value of employment history (Value_Employment) the server 110 determines a value that is based on the length of the lease applicant's 120 current employment to their immediate previous employment to a maximum period of five years. The server 110 accesses the employment history information entered by the lease applicant 120 and stored in the datastore 114. Any periods of unemployment longer than 90 days will negatively affect the lease applicant's 120 Value_Employment.

If the length of the lease applicant's 120 current employment, or the combination of current employment and immediate previous employment add up to five years, the server 110 will assign Value_Employment a maximum value, in this case five.

However if a lease applicant 120 has three years in their current employment, preceded by six months of unemployment the server will assign Value_Employment for the lease applicant being 60% of a maximum value, in this case three where the maximum is five.

Further, if the applicant has two years in their current employment, preceded by six months of unemployment the server 110 will assign Value_Employment for the lease applicant a value that is 40% of the maximum value, such as two where the maximum is five.

The value assigned to the predetermined criteria My Rating (Value_{—} AgentRating) allows the agent to score each lease application based on the criteria of the agent's choosing. Initially, Value_{—} AgentRating is assigned a default value of 50% of a maximum value, being five where the maximum is 10. Value_{—} AgentRating is updated by the agent 130 on the lease applicant's detail page or lease application detail page that provide the pop-up shown in FIG. 7(c). The factors the agent 130 can use to provide the score is determined by the agent 130 and will typically be subjective criteria such as relative strengths of references, previous history with the lease applicant or an established ranking process defined by the agency.

The final predetermined criteria of this example, being ID Verification is assigned a value (Value_IDVerification) based on the result of third party online ID verification such as by ID verifications system 142, and/or a manual ID verification by the agent 130. The value is directly proportionate to the percentage of applicants who have been verified and the maximum value is 100%. For example, if two people in a joint application and both are ID verified Value_ID Verification is 100. Alternatively, if two people are a joint lease application and only one lease applicant is ID verified, Value_ID Verification is set to 50. Further, if there are four people in a joint lease application and only three are verified then Value_ID Verification is 75.

The weighting of each predetermined criteria (Weight_Income, Weight_Employment, Weight_{—} AgentRating and Weight_IDVerification) may be pre-set to an default value and in turn a default position on the bar. For example, the pre-set weight values are stored in the datastore 114 for one or more criteria for one or more of:
the property itself, for example, the nature of the property, such as the high or low rental amount may impact the desirability for long term employment;
owner of the property, for example, owners of one or more properties may have a preference that their properties only be awarded to lease applications having strong income values and the weighting of income is pre-set accordingly for all their properties;
the real estate agent, for example, the real estate agent may prefer that the highest ranked lease applications are all verified so that they do not approach their client with a potentially illegitimate lease application;
the one or more lease applicants associated with the lease application, for example, where an agent has prior knowledge of a lease applicant, the weight given to the property agents rating may be set to be high; and
default in the absence of any of the above.

Weights of the criteria may be dynamically adjusted to update the ranking of the lease application. For example, a dynamic ranking user interface element 1010 with multiple adjustable bars may be used to dynamically adjust weights associated with the different criteria. The location of the adjustable marker on each bar has a mathematical relationship with the value of the weight used for the respective predetermined criteria represented by that bar. For example, a mid-way location will give a weighting at 50% of the maximum while a location at the far right of the bar will give the maximum value. Various user elements could be equally used to receive from the agent the weighting values, such as a text box for direct entry of a numerical value or a selection of a certain number of discreet weighting values.

For example, some agents 130 may select income as the most important, while other agents 130 may prefer employment history. Different combinations of weight values may be used and a preference may be saved as a pre-set value in the datastore 114 associated with a particular property, all properties managed by the agent 130, or a particular landlord. The dynamic ranking result 1023 (e.g. 1 for Mr L. Oliver) is displayed against the lease application on the interface 1000, where a smaller value indicates a better ranking.

An adjustment in the marker on the bar means a change in the weighting value for any of the four predetermined criteria. In turn this may change the rating value of the lease applications having updated weight values. Once the server 110 determines the values for the criteria income, employment history, ID verification and using the default or received “my rating” value, the server 110 further determines the weighting value of each criteria based on the location of the movement element on the adjustable bar. In this example, the weighting value has a linear relationship with the location of the movement element on the bar. For example, where the weighting value is a maximum of 10 and the movement element is placed 25% of the length from the far left, the weighting value for that criteria will be 2.5.

The server 110 then determines for each lease application a rating value. For example, the following formula could be used:

Rating Value=(Value_Income*Weight_Income)+(Value_Employment*Weight_Employment)+(Value_AgentRating*Weight_AgentRating)+(Value_IDVerification*Weight_ID_Verification)

The server 110 stores in the datastore 114 associated with the lease application the determined rating value.

Then the lease applications are ranked 1023 in the second user interface as shown in FIG. 10(a) according to their rating value to allow a property agent to review the two or more lease applications submitted for the property. In this case the, the lease application with the largest rating value belongs to Mr L. Oliver and is assigned rank 1. The lease application with the second highest rating value belongs to Mr B Hearder and is assigned rank 2. In this example, all lease applications are ranked in this manner.

In alternatives, the rating value is displayed on interface 1000 and ranking may be any spatial relationship that reflects the relative values of the rating of the lease applications. In other examples, two or more lease applications may be given an equal rank and displayed accordingly.

In some embodiments rankings are accompanied (or even replaced) by scores or other forms of quantifier derived from a rating algorithm, thereby to indicate relative strengths of applications. These ratings (or scores) may be numerical, graphical, or indicative of quality (or relative quality) in substantially any way. For instance, one embodiment implements a star rating approach, whereby strong applications (based on predefined scoring criteria) are assigned a relatively higher star rating, and poor applications (again based on predefined scoring criteria) are assigned a relatively higher star rating. This enables agent to, at a glance, assess whether applications are of high or poor quality. For example, an agent may choose to review only applications having a threshold star rating level. Also, an agent is able to quickly assess whether it is, for example, only the top two applications that are of great quality, or whether there are a large number of high quality applications.

In some embodiments, in addition to (or as an alternative to) objectively defined ratings derived from the rating algorithm, an interface is provided thereby to allow an agent to assign subjective ratings to individual applications based on the agent's review.

At any point in time the agent can adjust one or more markers on the bars to update the weighting value for any one or more of the four predetermined criteria. In turn this may update the rating value of the lease applications having updated one or more weight values according to the formulation defined above. Once the server 110 determines the updated value of the rating this causes the server 110 to store the updated weights and values, but also cause an updated computer generated second user interface 220 to be provided to the property agent. Using the updated second user interface the agent can review an updated ranking that is the result of the updated rating. This updating process is typically dynamic with the second user interface reflecting in the ranking any resulting changes in the ratings caused by changes in the weightings substantially immediately.

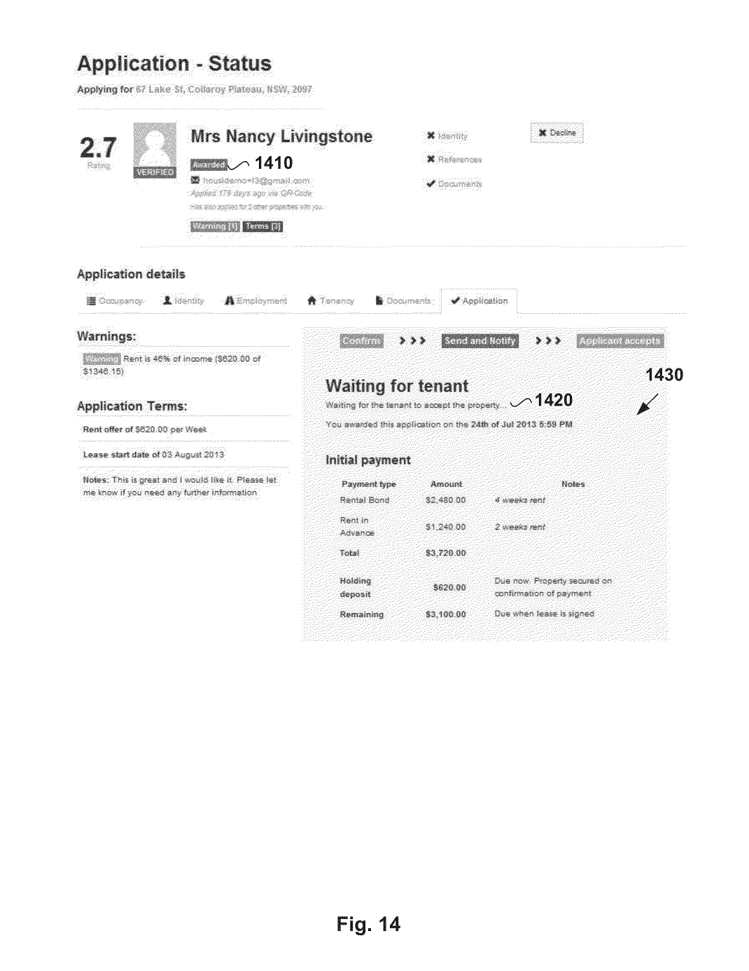

Before lease applications are shortlisted, the agent 130 may contact the applicants 120 to confirm their interest in the property typically starting from the highest ranked lease application. The agent 130 may send an email to each applicant 120 via the interface shown in FIG. 14. The email may be generated based on a confirmation email template specified by the agent 130 during the registration process. If an applicant 120 does not confirm their interest within a specified period, their application may be declined.

One or more lease applications may then be shortlisted or declined using interface elements such as a “Shortlist” button 1031 and a “Decline” button 1032 respectively. Although not shown in FIG. 10, more than one lease applications may be shortlisted by the agent 130 who is typically influenced by the dynamic ranking results. In one example implementation, a threshold may be set by the agent 130 such that the server 110 shortlists applicants ranked more than the threshold or have a rating value more than the threshold. The list of shortlisted lease applications may then be sent to the landlord for further review and/or approval.
Details of each lease application may also be further reviewed using different tabs shown in FIG. 10(b), i.e. “Overview”, “Identity”, “Employment”, “Tenancy”, “Documents” and “Application”.
Referring first to FIG. 10(b), the “Application” tab displays any warnings 1040 generated by the server 110 and application terms 1042 specified by the applicant 120. The server 110 may assess the ratio of the rent to the applicant's income based on information provided by the applicant 120. For example, in the case of “Mrs N Livingstone”, the server 110 calculates the ratio and displays a warning 1040 “Rent is 48% of income” for the agent 130 to review.
Referring to FIG. 11(a), the “Overview” tab displays the applicant's name, marital status, number of children, pets and vehicles as well as applicant's income, rental amount, lease state date and lease length.
Referring to FIG. 11(b), the “Identity” tab displays the applicant's personal information, contact details, referee information and emergency contact details. The “Notes” section sets out the ID verification details of the applicant 120. If the applicant has not completed a ID verification check, the agent 130 can initiate the check and tick the “verified” checkbox under the notes field. In this case, the “Unverified” status of the applicant 120 changes to “Verified”; see 1110.
Referring to FIG. 11(c), the “Employment” tab displays employment information of the applicant 120. Clicking on the “View” button (see 1120) will display further details of the applicant's occupation, contact name, income, address and contact details. The employment information may be manually verified by the agent 130 or performed by the server 110 by connecting to a third party system 140. Once verified, the status of the applicant changes from “Unverified” to “Verified”; see 1130.
Referring to FIG. 12(a), the “Tenancy” tab displays the applicant's tenancy reference information, such as tenancy period, rent, agency or landlord. Clicking the “View” button (see 1210) will display the example interface in FIG. 12(b), which provides more information such as the reason for leaving, address details and contact details. Once the tenancy reference information is manually verified, the “Unverified” status 1220 in FIGS. 12(a) and 1230 in FIG. 12(b) changes is changed to “Verified”. The agent 130 may also provide and save any relevant notes for future references; see 1240. The tenancy reference information may be verified by the server 110 via the tenancy or credit check system 144. In one example, the result returned by the system 144 is a certificate verifying the information provided by the lease applicant 120, such as in Portable Document Format (PDF).
Referring to FIG. 12(c), the “Documents” tab displays a list of supporting documents uploaded by the lease applicant 120 to support their lease application and confirm their identity. The documents may include photo ID, payslips, tax return information and business registration number for example. The tab allows downloading of the documents by the agent 130; see 1250.

### Lease Offer Generation and Acceptance

Once the lease applications have been processed, a lease offer may be generated and accepted according to block 228 in FIGS. 2(c) and 216 in FIG. 2(b).

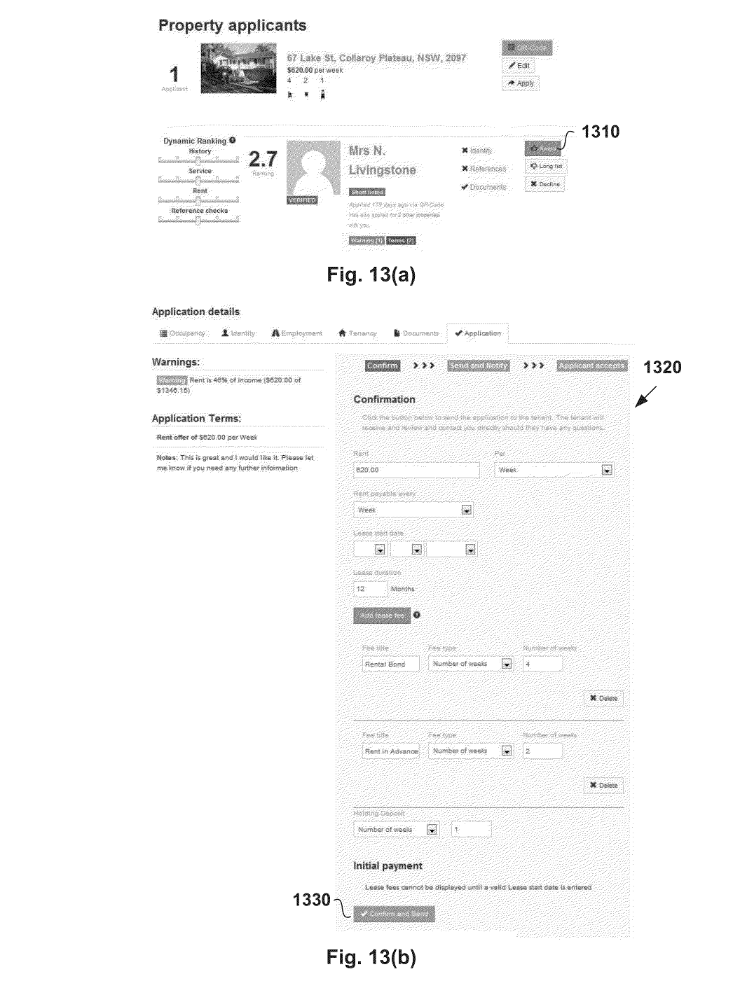

FIG. 13(a) shows an example user interface for awarding a property to a lease application that was previously shortlisted. Clicking the “Award” button 1310 the server 110 generates the interface in FIG. 13(b) which provides user interface elements for entering information relating to the following: rent amount, rent payment period, start date of lease, lease duration, rental bond, rent in advance, holding deposit, and payment options.

Once the “Confirm and Send” button 1330 is clicked, a lease agreement will be generated by the server 110 and delivered to the applicant 120. In one example, the lease agreement may be generated based on the location of the property. This is because different states may have different tenancy laws and corresponding requirements. In this case, appropriate agreement clauses will be determined and included in the agreement by the server 110 based on the location of the property.

The example interface in FIG. 14 is then presented to the agent 130 to confirm that the lease agreement has been generated and sent. In this case, the status of the property changes from “Shortlisted” to “Awarded” 1410. The interface also sets out the application status (“Waiting for the tenant to accept the property . . . ”) 1420 and payment required from the lease applicant 120; see 1430.

The lease offer may then be reviewed by the lease applicant 120 via a user interface provided by the lease applicant interface module 210 at the server 110. The lease agreement and conditions set by the agent 130 may be reviewed. Once the lease applicant 120 has accepted the lease offer by clicking the “accept” button, the status of the property changes from “Awarded” to “Accepted”. The lease agreement may be signed online via the server 110 or in person at the agent's office. Any initial payment required may be made electronically via the server 110 and payment system 146 in FIG. 1.

Referring back to FIG. 3, the lease applicant nominates whether other people will be living at the property. Typically, a lease application may have two or more lease co-applicants.

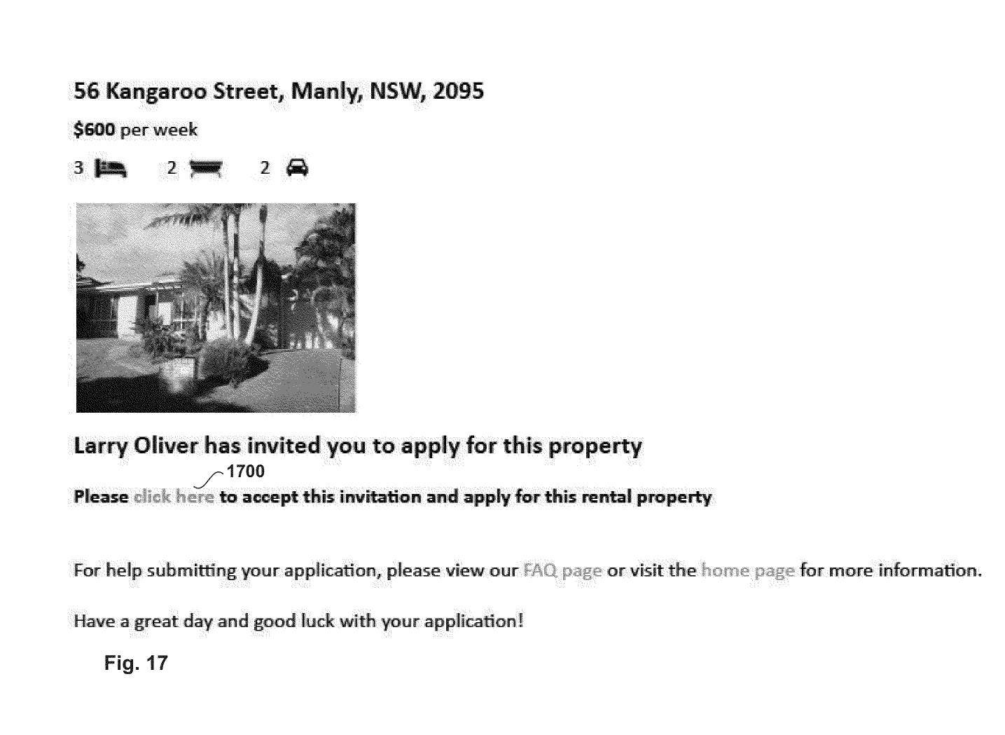

In this case the primary lease applicant uses the feature at 350 of FIG. 3 to nominate secondary applicants. The primary lease applicant provides at least the name and email address of each of the secondary lease applicants. As a result, the server 110 sends an email to each secondary lease applicant as shown in FIG. 17.

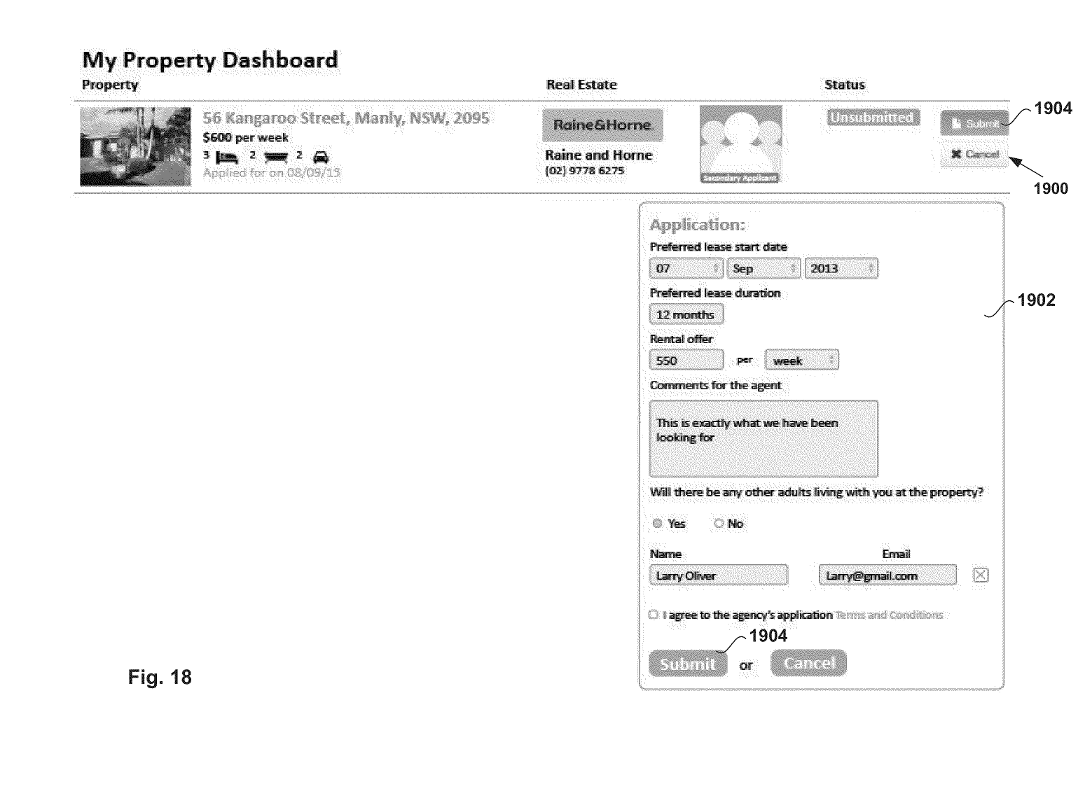

By clicking on the link 1700 provided, the secondary applicant is taken to the user interface similar to FIGS. 3, 4 and 5 so that the secondary applicant can register 212. Once registered, the secondary applicant is presented with the user interface of FIG. 18 which shows the details of the property 1900 that the primary lease applicant has invited them to apply for. Also, the details of the lease application provided or previously confirmed by the primary applicant is displayed at 1902. The secondary lease applicant selects the user interface element 1904 to agree to the terms and conditions and submit a lease application to this property with the primary applicant. In this example the secondary lease applicant cannot adjust the terms of the application, only the primary lease applicant can do that. In particular, in this example, the primary lease applicant is the only applicant that can make initial terms of offer, accept awarded properties or withdraw the application.

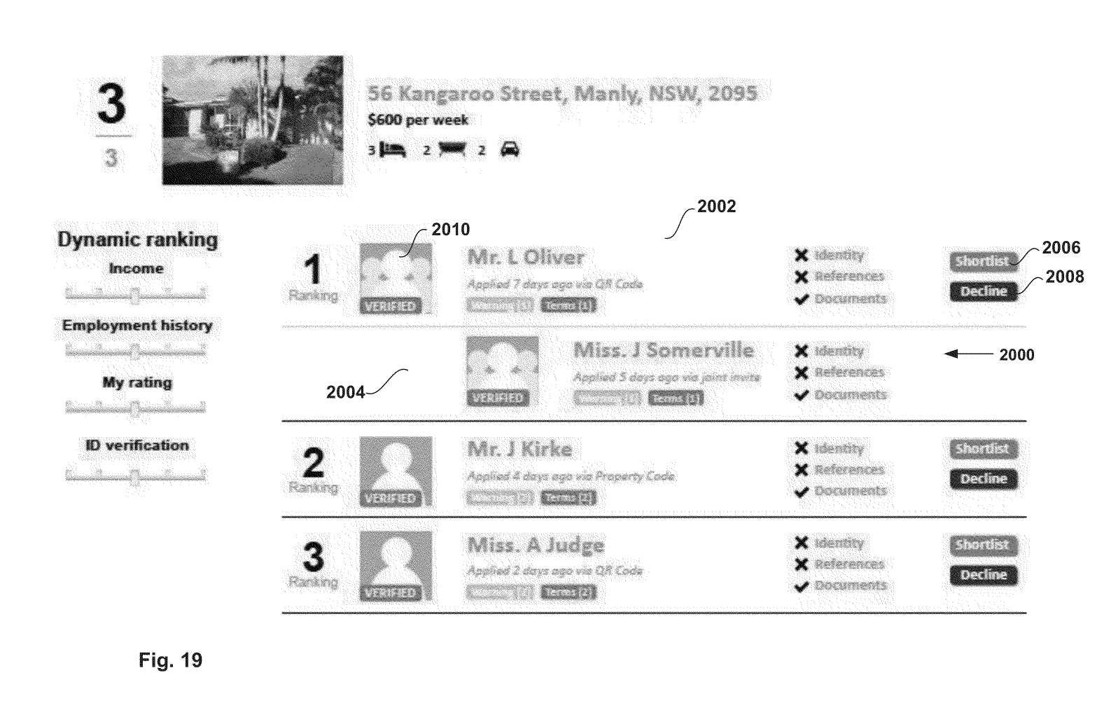

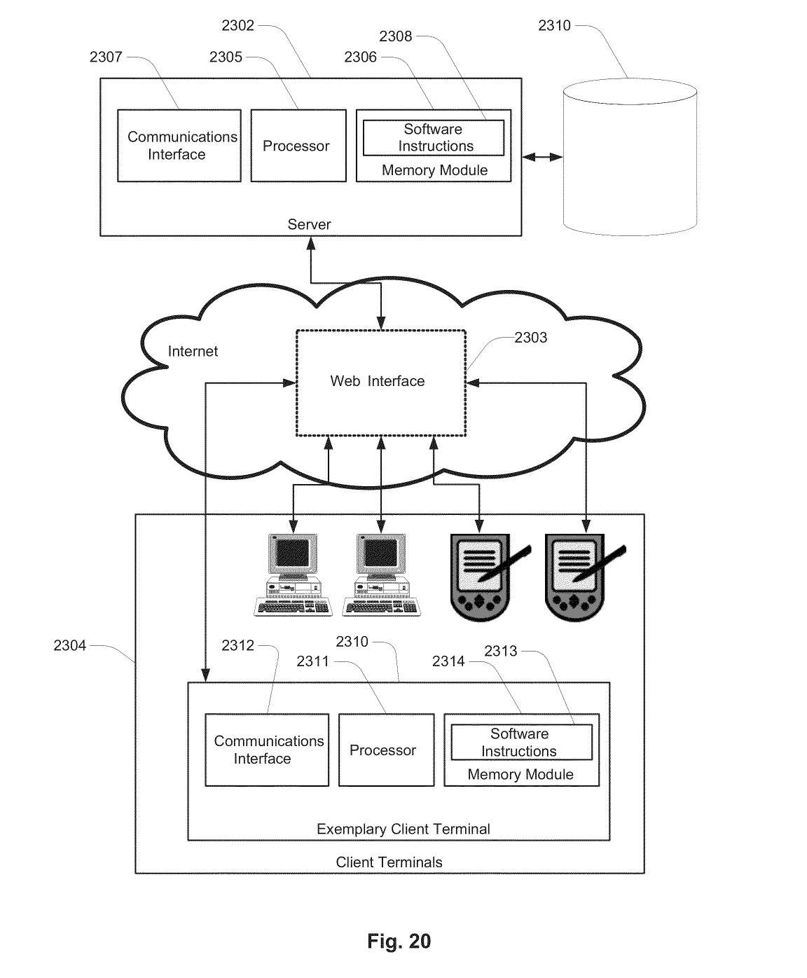

In the case of multiple applicants for a lease application, this is shown to the agent similarly to interface of FIG. 10(a) but instead as shown in FIG. 19. As can be seen the lease application with the ranking highest ranking 2000 has two applicants 2002 and 2004. In this example, the first listed applicant 2002 is the primary applicant followed by one or more secondary applicants 2004. The icon 2010 for the joint application clearly shows that the lease application 2000 is comprised of multiple applicants by having the silhouette of multiple people rather than one person. In another example, the icon 2010 includes a number indicating the number of applicants associated with the lease application, in this case 2 (not shown).

The agent 130 deals with the lease application as a whole, meaning any action (such as shortlist 2006 or decline 2008) is taken to the application 2000 as a whole. In the same way, while each secondary applicant receives all information relating to the lease application, only the primary lease applicant can agree and accept or decline a lease for the property.

Rating each lease application takes account the relevant factors of the primary lease applicant and all the secondary lease applicants. In some embodiments one or more criterions are scored based on a best (or worse) individual score determined by scoring each of the applicants. For example, a Value_Employment score for the application is defined by the best Value_Employment for any of the applicants. Concurrently, one or more other criterions are scored based on a collective score for all applicants. For example, Value_Income for an application having multiple co-applicants is determined as a collective score derived from the cumulative Value_Income scores of the individual co-applicants. In some instances averaging is used (for example averaging scores of the multiple co applicants in respect of a given criterion).

For example, Value_Income is sum of the income of each of the applicants. Value_Employment is longest current employment value of all of the lease applicants. Value_AgentRating is applied by the agent to the whole application 2000 rather than the individuals. Value_IDVerification is taken combined result of each verified applicant, but also weighted by the number of applicants. For example, if 1 of 2 co-applicants are verified, Value_IDVerification is taken as the value of the verified co-applicant weighted by 50% (that is in additional to the Weight_IDVerification) or if 2 of 3 co-applicants are verified, the value is taken as the sum of the value for the verified co-applicants weighted by 67%.

In some embodiments a co-applicant cannot submit a second joint application for the same property but can be a co-applicant or applicant on a different property.

### Application-Centric Handling

In some embodiments, a database structure is configured such that each lease application is uniquely identifiable, and able to be associated with one or more applicants (each applicant also being uniquely identifiable). In this manner, a lease application is described by a set of data including an application identifier, and one or more applicant identifiers (being more than one for cases where a lease application has multiple applicants).

In a preferred embodiment, a user completes a personal profile (for example with personal, employment, income, credit, and other details), and is able to associate that personal profile with one or more lease applications. This may include associating the personal profile as an applicant, or as a joint applicant. In either case, the generation of a personal profile as a one-time event (although it may be selectively updated), and may be used for the purpose of multiple lease applications.

In some embodiments a personal profile is able to be associated with an application as either an applicant or a non-applicant occupant, thereby to provide in the context of an application details of non-applicant occupants.

In some embodiments, a user is enabled to cause information in their personal profile (being all or a subset of that information) to be centrally verified, such that it is provided to agents in a per-verified form. This may in some cases, involve a cost. Centralised verification may be preferably to applicants, for example in the case of credit checks (noting that there may be negative repercussions resulting from multiple third parties requesting credit checks).

In cases where agents are responsible for verification of information in a user's personal profile, that is preferably handled on a per-application basis.

In some embodiments a functionality is provided whereby multiple agent users associated with a common agency are configured to automatically share data regarding personal profile verification events. For example, if a first agent within a given agency manually verifies a particular user's employment history, a notification of that verification is provided to a second agent within the given agency thereby to prevent the second agent going to the effort of performing the same manual verification.

### Preference Filtering

In some embodiments, the above-described ranking methodologies are supplemented with filtering based on a set of preferences. In overview, various characteristics of an applicant (or applicants) associated with an application re collected via the application process, such as whether they are smokers, have pets, are holders of limited work visas, and so on. The agent is enabled to set filters thereby to restrict certain applications from being shortlisted (and/or accepted and/or scored), or to adjust the ranking process.

One exemplary approach is to provide an agent with a filtering interface which provides a list of characteristics (such as characteristics relating to smoking, pets, and so on) and check boxes (for example a “must have” or “must not have” options) thereby to enable hard filtering of results. In some cases an additional “preferred” option is provided, which applies a weighting to an application (the extent of that weighting optionally being controlled by an agent) thereby to cause applications satisfying the “preferred” characteristics to appear higher in rankings.

Another exemplary approach is to define an “ideal tenant” by completing an electronic form (such as a checklist or the like) thereby to input desirability of various characteristics (for example on a scale, or a binary “yes/no” basis). This defines criteria for a subjective “ideal tenant”. Each application is provided an overall score for how well it fits the ideal tenant criteria, for example as a percentage rating (100% for a direct match, for example where an applicant possesses all characteristics identified as desirable in the checklist). This score may be factored into the rating process in a similar manner to employment, income, and the like, or alternately be separately displayed such that an agent can observe in results both a position in ratings based on objective factors and a relationship to the subjective ideal tenant criteria. The “ideal tenant” may be defined by, for example, an agent, a property owner, in collaboration between an agent and a property owner, or by other approaches.

Ranking with Positive Rating Details

In some embodiments, rankings are accompanied by detailed information concerning the application, for example detailed information derived from data upon which rankings are determined.

In a preferred embodiment, a set of predefined “application observations” are defined. Each application observation is associated with satisfaction rules (which may be defined by reference to criterion scores and/or data values associated with an application), and associated with a plain language comment regarding the application's performance. For example, this is applied such that applications with scores for Value_Income above a certain threshold value are assigned an application observation having a comment such as “applicant(s) capacity to afford rent is extremely favourable”. An algorithm is configured to identify none or more application observations for each application, which are able to be viewed by an agent via the user interface.

In a preferred embodiment, the application observations are defined such that only positive observations are made. That is, observations are made in respect of particularly good aspects of an application only, thereby to highlight the strengths of one or more applications.

In some embodiments the application observations may include negative observations, for example by raising “warning flags” or the life when predefined conditions are met. Rules concerning such predefined criteria may be defined at an agent level, and/or at a global (across-all-agent) level. For example, a warning flag may be raised where a periodic rent amount is greater than a threshold proportion of an applicant's income amount for a corresponding period.

### Agent Summary Dashboard

In some embodiments, an agent is provided with an interface that provides detailed information regarding lease applications one or more properties. For example, data derived from multiple lease applications for a given property (or group of properties, for example properties identified based on search criteria) is displayed via one or more graphs or charts, thereby to provide a visual “snapshot” of applications. This may include information such as:
A graph showing a distribution of applications for a given property across various income bands.
A graph showing number of applications received for a given property as a function of time.
A graph showing a relationship between number of applications received and rental price for properties in a given region.

Various other forms of information may also be presented. This may be provided thereby to enable an agent to derive knowledge regarding the nature of applications for properties they manage at a high level, without needing to open/access/review any individual applications.

### Geofencing Functionalities

As noted some embodiments a token is defined by reference to GPS coordinate data for a property. In such embodiments, GPS data received from a mobile device's GPS module is decoded thereby to provide access to a lease application for a relevant property based on the mobile device's location.

In a similar manner, GPS coordinate data may be used by a mobile application executing on a user device thereby to automate various other processes relevant to the lease application process. This may include informing a user when they are in the proximity of a property for lease, providing details and/or directions to lease properties in a regions proximal the user, and tracking user activity at various open home inspections for registered properties.

### Device 122, 132

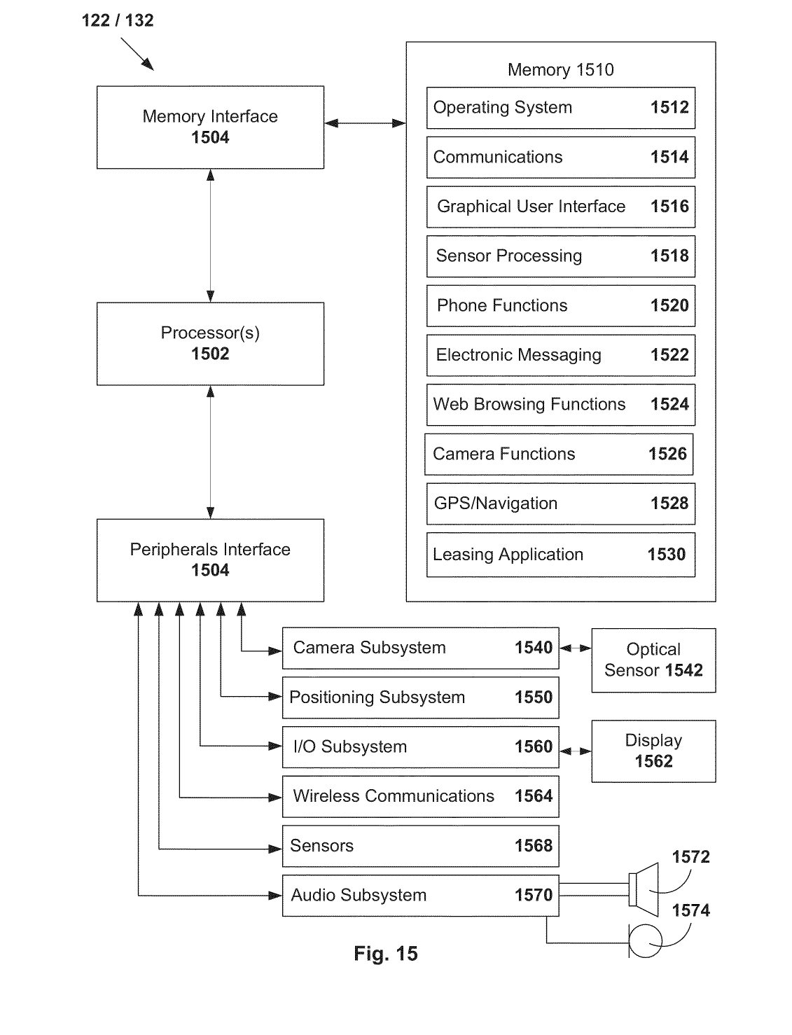

Referring now to FIG. 15, an example structure of a device 122, 132 operated by a lease applicant 120 or agent 130 is shown. In this case, the device 122/132 is a mobile electronic device with a touch-sensitive display. The electronic device 122, 132 comprises one or more processors 1502 in communication with a memory interface 1504 coupled to memory 1510, and a peripherals interface 1506. The memory 1510 may include random access memory and/or non-volatile memory, such as magnetic disc storage devices etc.

The memory 1510 stores various applications 1530 including the messaging application 144; an operating system 1512; and executable instructions to perform communications functions 1514; graphical user interface processing 1516; sensor processing 1518; phone-related functions 1520; electronic messaging functions 1522; web browsing functions 1524; camera functions 1526; and GPS or navigation functions 1528.

The applications 1530 implemented on the electronic device 122, 132 include an property leasing application 1530 to connect to the server 110 according to the examples in FIG. 1, FIG. 2(a), FIG. 2(b) and FIG. 2(c). The property leasing application 1530 may include a code scanner to scan a two-dimensional graphic (e.g. QR code) generated for a property for lease. For example, the property leasing application 1530 may be a web browser software application that can navigate the web-based user interfaces. In a further examples, if the mobile user device 122/132 is an Apple device, the property leasing application 1530 may be a downloadable “App” that is available through the Apple App Store (trade marks of Apple, Inc). Similarly, the property leasing application 1530 may be downloaded from the “Blackberry App World” for Blackberry devices (trade marks of Research In Motion Limited), and from the “Android Market” for Android devices (trade marks of Google, Inc.). The property leasing application 1530 may also be pre-programmed on the device 122/132. The App operates to scan the QR code and display the first user interface.

Other applications (not shown for simplicity) may also be implemented, such as a web browsing application, an email application, a telephone application, a video conferencing application, a video camera application, a digital camera, a photo management application, a digital music application, a digital video application, etc.

Sensors, devices and subsystems can be coupled to the peripherals interface 1504 to facilitate various functionalities, such as the following.
Camera subsystem 1540 is coupled to an optical sensor 1542, such as a charged coupled device (CCD) or a complementary metal-oxide semiconductor (CMOS) optical sensor, to facilitate camera functions.
Positioning subsystem 1550 collects location information of the device 122/132 by employing any suitable positioning technology such as GPS Assisted-GPS (aGPS). GPS generally uses signals from satellites alone, while aGPS additionally uses signals from base stations or wireless access points in poor signals condition. Positioning system 1550 may be integral with the mobile device or provided by a separate GPS-enabled device coupled to the electronic device 122/132.
Input/Output (I/O) subsystem 1560 is coupled to a touch-sensitive display 1562 sensitive to haptic and/or tactile contact via a user, and/or other input devices such as buttons. The touch-sensitive display 1562 may also comprise a multi-touch sensitive display that can, for example, detect and process a number of touch points simultaneously. Other touch-sensitive display technologies may also be used, such as display in which contact is made using a stylus. The terms “touch-sensitive display” and “touch screen” will be used interchangeably throughout the disclosure. In embodiments where user interfaces are designed to work with finger-based contacts and gestures, the device 122/132 translates finger-based input (which is less precise due to the larger area of finger contact) into more precise pointer- or cursor-based input for performing actions desired by the user 140.
Wireless communications subsystem 1564 is designed to allow wireless communications over a network employing suitable communications protocols, standards and technologies such as GPRS, EDGE, WCDMA, OFDMA, Bluetooth, Wireless Fidelity (WiFi) or Wi-MAX and Long-Term Evolution (LTE) etc.
Sensors 1568, such as a motion sensor, a light sensor and a proximity sensor are used to facilitate orientation, lighting and proximity functions, respectively.
Audio subsystem 1570 can be coupled to a speaker 1572 and microphone 1574 to facilitate voice-enabled functions such as telephony functions.

Although one example has been provided here, it will be appreciated that other suitable configurations capable may be used.

### Server 110

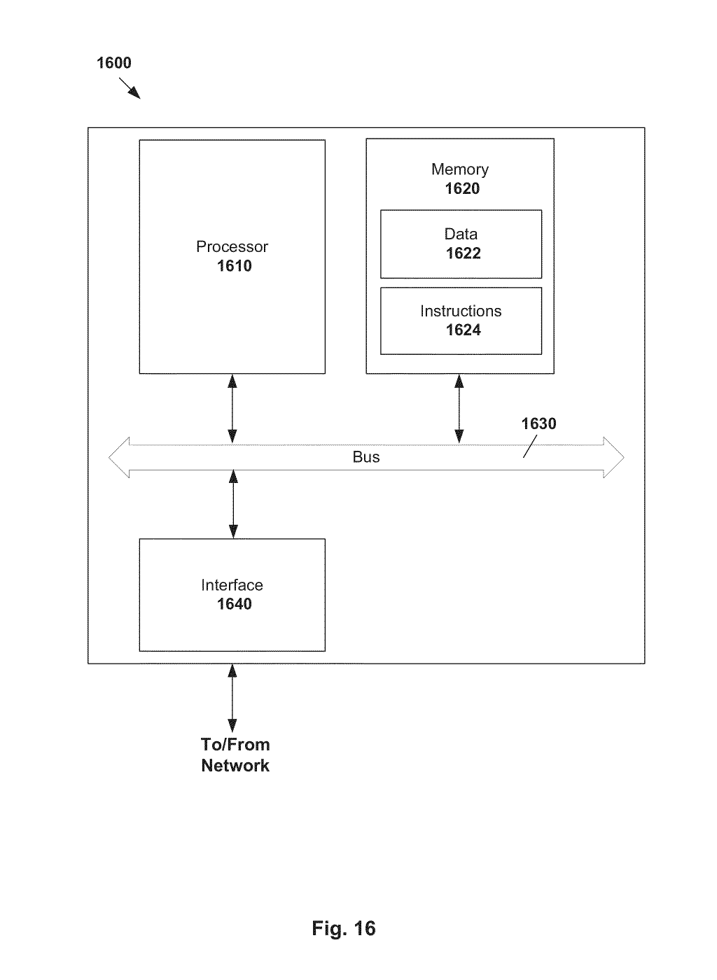

The above examples can be implemented by hardware, software or firmware or a combination thereof. Referring to FIG. 16, an example device 1600 capable of acting as a server 110 in FIG. 1 is shown.

The example computing device 1600 includes a processor 1610, a memory 1620 and a network interface device 1640 that communicate with each other via bus 1630. The memory 1620 stores any necessary data 1622 to store machine-readable instructions to perform any of the methods and processes described in the present disclosure.

The methods, processes and functional units described herein may be implemented by hardware (including hardware logic circuitry), software or firmware or a combination thereof. The term ‘processor’ is to be interpreted broadly to include a processing unit, ASIC, logic unit, or programmable gate array etc. The processes, methods and functional units may all be performed by the one or more processors 1610; reference in this disclosure or the claims to a ‘processor’ should thus be interpreted to mean ‘one or more processors’. In particular, the processor 1610 under instruction 1624 generates the graphic and the rating values, and also to cause data to be stored in memory, including a remote datastore.

Although one network interface device 1640 is shown in FIG. 16, processes performed by the network interface device 1640 may be split among multiple network interface devices (not shown for simplicity). As such, reference in this disclosure to a ‘network interface device’ should be interpreted to mean ‘one or more network interface devices”. The network interface operates to provide the first and second user interfaces as described here, being typically sending content to be displayed on the interface.

Although not shown, the server 110 may be implemented using cloud computing technologies. In one example, the server 110 may be implemented on a hardware device that has been virtualized into multiple logical tiers. The server 110 may then communicate with CMS and CRM systems associated with the agents 130 via Application Programming Interface (API) calls for example. Information of lease applicants 120 and property agents 130 may be stored separately on a secure datastore.

Further, the processes, methods and functional units described in this disclosure may be implemented in the form of a computer software product. The computer software product is stored in a storage medium and comprises a plurality of instructions for making a processor to implement the methods recited in the examples of the present disclosure.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

It will be appreciated that many of the actions taken by the server 110 and the resulting first and second user interfaces are automatic, in that steps can be performed without additional input or manual entry to the server 110.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

The first and second user interfaces could provide additional functionality than that described here. For example, where a list of properties is displayed, such as on FIG. 7(a), whether to the agent or the lease applicant, the properties can be sorted and ranked according to any one or more criteria, including but not limited to, alphabetically based on the suburb name, rental amount, age (time) that the property has been listed for, agent name, number of rooms, status type (e.g. awarded, shortlisted, declined).

Another example of the further functionality of the first and second interface relates to when a list of lease applications is displayed, such as on FIG. 10(a). Typically this is displayed to the agent and the agent can chose to sort and rank the candidates for display according to alternative or additional criteria than the determined ranking. The one or more criteria includes alphabetically based on the lease applicants name, agent rating score, by method or source of the application (e.g. QR code), by number of rooms applies for, by the rental amount applied for/being offered by the lease candidate and by suburb applied for.

Another additional functionality allows agents greater customisation. For example, the agent can add questions and upload requests of the applicant that are in addition to the completed standard online application or entering terms and conditions that are specific to the property for lease.

Yet a further functionality is the ability of the property agent to update the rental amount sought for a property. This change also updates the stored status of the property to “updated”. Also, a lease applicant can offer a rental amount different to the rental amount actually sought by the property agent.

In yet another example, when the software used by the device of the agent or the applicant could be implemented by way of an App and many of the functionalities/and or data could be served locally. That means a limited set of data and some processing could be performed by the device rather than the server, for example re-order the properties according to price.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### Exemplary Client-Server Framework

In some embodiments, methods and functionalities considered herein are implemented by way of a server, as illustrated in FIG. 23. In overview, a web server 2302 provides a web interface 2303. This web interface is accessed by the parties by way of client terminals 2304. In overview, users access interface 2303 over the Internet by way of client terminals 2304, which in various embodiments include the likes of personal computers, PDAs, cellular telephones, gaming consoles, and other Internet enabled devices.

Server 2303 includes a processor 2305 coupled to a memory module 2306 and a communications interface 2307, such as an Internet connection, modem, Ethernet port, wireless network card, serial port, or the like. In other embodiments distributed resources are used. For example, in one embodiment server 2302 includes a plurality of distributed servers having respective storage, processing and communications resources. Memory module 2306 includes software instructions 2308, which are executable on processor 2305.

Server 2302 is coupled to a database 2310. In further embodiments the database leverages memory module 2306.

In some embodiments web interface 2303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 2304 maintain software instructions for a computer program product that essentially provides access to a portal via which the framework is accessed (for instance via an iPhone app or the like).

In general terms, each terminal 2304 includes a processor 2311 coupled to a memory module 2313 and a communications interface 2312, such as an internet connection, modem, Ethernet port, serial port, or the like. Memory module 2313 includes software instructions 2314, which are executable on processor 2311. These software instructions allow terminal 2304 to execute a software application, such as a proprietary application or web browser application and thereby render on-screen a user interface and allow communication with server 2302. This user interface allows for the creation, viewing and administration of profiles, access to the internal communications interface, and various other functionalities.

### CONCLUSIONS AND INTERPRETATION

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer-implemented method configured to enable ranking of property lease applications, the method comprising:
providing an interface that is configured to receive, from a plurality of applicant users of remote terminals, respective sets of lease application data for property lease applications;
based on the received data, maintaining a database of lease applications;
applying a rating algorithm thereby to rate each of a plurality of lease applications, wherein the rating algorithm rates each application according to a plurality of predetermined criterions (C₁, C₂ . . . Cₙ) having associated weights (W₁, W₂, . . . Wₙ), wherein the criterions are scored individually for each application, and wherein the weights are applied consistently across lease applications made in respect of a given property;
providing a weighting modification interface configured to enable a user to define values for one or more of the associated weights (W₁, W₂, . . . Wₙ) to be applied by the rating algorithm in respect of lease applications made in respect of a given property, thereby to influence the rating algorithm; and
providing output indicative of a ranking of a set of lease applications made in respect of a given property based on application of the rating algorithm as influenced by the values defined via the weighting modification interface.

2. The computer-implemented method of claim 1, wherein the predetermined criterions are one or more of:
based on income;
based on credit rating information;
based on employment history;
based on a rating determined by the property agent; and
based on whether identification of one or more lease applicants of a lease application have been verified.

3. The computer-implemented method of claim 2, wherein the weighting modification interface enables the agent user to, following output of the ranking, define updated values for one or more of the associated weights (W₁, W₂, . . . Wₙ), such that the rating algorithm subsequently applies the updated values.

4. The computer-implemented method of claim 3, wherein the weighting modification interface is configured to be accessed by a user registered as a property lease agent.

5. A computer-implemented method configured to enable ranking of property lease applications, the method comprising:
(a) providing an interface determining a rating for each of the two or more lease applications submitted for a property according to predetermined criteria and associated weights;
(b) providing over the communications network a computer generated second user interface to a property agent to review a ranking of the two or more lease applications submitted for the property based on the ratings, and to receive from the property agent one or more updated weights;
(c) determining an updated rating for one or more lease applications submitted for the property according to the one or more updated weights; and
(d) providing over the communications network an updated computer generated second user interface to the property agent to review an updated ranking of the two or more lease applications based on the updated rating.

6. A computer-implemented method for property lease over a communications network, the method comprising:
generating a token that uniquely identifies a property for lease, wherein the token is readable by a mobile device thereby to provide a request to a server device over a communications network, the request being indicative of the property;
in response to the request, providing over the communications network a first user interface configured to enable a user of the mobile device to submit a lease application in respect of the property scanned; and
providing over the communications network a second user interface to a property agent to review lease applications submitted via the first user interface.

7. The computer-implemented method of claim 6, wherein the token includes a graphic is optically readable by the mobile device.

8. The computer-implemented method of claim 7, wherein the lease applications are ranked according to predetermined criteria, the predetermined criteria being one or more of:
based on income;
based on credit rating information;
based on employment history;
based on a rating determined by the property agent; and
based on whether identification of one or more lease applicants of a lease application have been verified.

9. The computer-implemented method of claim 8, wherein the first user interface configured to enable a user of the mobile device to invite a further user to submit co-applicant data in respect of the lease application.

10. The computer-implemented method of claim 1, wherein the weighting modification interface enables the agent user to, following output of the ranking, define updated values for one or more of the associated weights (W₁, W₂, . . . Wₙ), such that the rating algorithm subsequently applies the updated values.

11. The computer-implemented method of claim 1, wherein the weighting modification interface is configured to be accessed by a user registered as a property lease agent.

12. The computer-implemented method of claim 2, wherein the weighting modification interface is configured to be accessed by a user registered as a property lease agent.

13. The computer-implemented method of claim 6, wherein the lease applications are ranked according to predetermined criteria, the predetermined criteria being one or more of:
based on income;
based on credit rating information;
based on employment history;
based on a rating determined by the property agent; and
based on whether identification of one or more lease applicants of a lease application have been verified.

14. The computer-implemented method of claim 6, wherein the first user interface configured to enable a user of the mobile device to invite a further user to submit co-applicant data in respect of the lease application.

15. The computer-implemented method of claim 7, wherein the first user interface configured to enable a user of the mobile device to invite a further user to submit co-applicant data in respect of the lease application.
